(19) United States
(12) Patent Application Publication
(10) Pub. No.: US 2013/0127950 A1
(43) Pub. Date: May 23, 2013

(54) COATING FOR PROVIDING A WETTING GRADIENT TO AN ORIFICE SURFACE AROUND AN ORIFICE AND METHOD FOR APPLYING SAID COATING

(71) Applicant: OCE TECHNOLOGIES B.V., Venlo (NL)

(72) Inventors: Dan CRINGUS, Venlo (NL); Marcus J. VAN DEN BERG, Venlo (NL); Hans REINTEN, Velden (NL)

(73) Assignee: OCE TECHNOLOGIES B.V., Venlo (NL)

(21) Appl. No.: 13/739,062

(22) Filed: Jan. 11, 2013

Related U.S. Application Data
(63) Continuation of application No. PCT/EP2011/062059, filed on Jul. 14, 2011.

(30) Foreign Application Priority Data
Jul. 26, 2010 (EP) 10170738.8
Oct. 1, 2010 (EP) 10185814.0

(51) Int. Cl. B41J 2/16

(52) U.S. Cl. CPC B41J 2/1606
USPC 347/45

(57) ABSTRACT

A coating provides a wetting gradient to an orifice surface, the coating having a local coverage that decreases with increasing distance from an orifice. A method is provided for applying a wetting gradient on an orifice surface. The wetting gradient is formed by providing a compound for forming a coating and locally bonding this compound to the orifice surface. A print head is provided with an orifice surface, wherein the orifice surface has a wetting gradient provided around an orifice using the method for applying a wetting gradient on an orifice surface.

The present invention relates to a coating for providing a wetting gradient to an orifice surface, to a method for applying said coating and to an ink jet printer comprising an orifice plate provided with said coating.

### BACKGROUND OF THE INVENTION

In a known print head, the print head comprises an orifice surface, the orifice surface having arranged thereon at least one orifice. Ink is ejected from the print head through said orifice. When printing, ink may be spilled on the orifice surface of the print head. Ink present on the orifice surface close to an orifice may have a negative influence on the performance of a print head during jetting of the ink. Therefore, it is important to prevent presence of ink on the orifice surface close to an orifice.

EP 2 072 261 describes an orifice surface, having applied thereon a wetting gradient around an orifice, i.e. having a wettability changing with a distance from the orifice. The wettability of a surface is correlated to the contact angle between a surface and a droplet present on that surface. The more wettable the surface is, the smaller is the contact angle. The smaller the contact angle, the more spreading of the droplet of fluid over the surface. On a wetting gradient, as disclosed in EP 2 072 261 and as used herein, the wettability of the surface gradually changes as a function of the position on the surface. As a consequence, the contact angle between the surface and a droplet on that surface changes as a function of the position on the surface. The droplet tends to move from a part of the surface having lower wettability towards a part of the surface having higher wettability. Hence, a wetting gradient generates a driving force for a droplet to move on the surface towards a part having lower wettability.

In EP 2 072 261, the wetting gradient is created on an orifice surface by providing the orifice surface with a patterned anti-wetting coating, wherein the pattern is more dense close to an orifice and becomes less dense with increasing distance from the orifice. As a consequence, a wetting gradient is provided on macroscopic scale, by providing a pattern on a microscopic scale. Hence, this wetting gradient prevents the presence of ink close to an orifice. However, since the wetting gradient according to EP is provided by providing a pattern on a microscopic scale, and not, by a process providing a random distribution of the coating forming the wetting gradient, the wetting gradient created according to EP 2 072 261 does not provide a wetting gradient on a microscopic scale. Moreover, it is difficult and consequently expensive to accurately apply such a patterned coating around a nozzle.

It is an object of the invention to provide a wetting gradient on an orifice surface, wherein the wetting gradient is provided both on a macroscopic and a microscopic scale. It is a further object of the invention to provide a method for applying a wetting gradient on an orifice surface in an efficient, cost-efficient and accurate way.

### SUMMARY OF THE INVENTION

The object of the invention is achieved in a coating for providing a wetting gradient to an orifice surface around an orifice, the coating providing anti-wetting properties to the orifice surface, the coating having a local coverage, the local coverage being highest close to the orifice, the local coverage decreasing gradually with decreasing distance from the orifice, wherein the coating is distributed randomly.

A print head, used in an ink jet printer, comprises an orifice surface, the orifice surface having arranged therein at least one orifice. Marking material, for example ink, is ejected through the orifice onto an image-receiving member. Marking material may be spilled on the orifice surface. Marking material present on the orifice surface may interact with marking material that is ejected through the orifice, thereby influencing the jetting performance of the print head. To prevent the jetting performance being influenced by marking material present on the orifice surface, the marking material should be removed from the vicinity of the orifice. It is known to remove marking material from the vicinity of an orifice by applying a wetting gradient around the orifice. As above mentioned, it is desirable to control a wetting property of the ink and the orifice surface such that a wetting gradient is provided, e.g. around the orifice.

In the present invention, a coating is formed on an orifice surface upon bonding of a compound for forming the coating to the orifice surface. The amount of coating that is locally bond to the orifice surface per unit area is the local coverage of the coating. The coverage of coating decreases gradually with increasing distance from the orifice. This is in contrast to, for example, a coating provided on a surface, wherein the coating is provided as a pattern around the orifice, the coating having a homogeneous coverage throughout the pattern. Outside of the pattern, there is no coating. Although in the latter example, the coverage of coating decreases with increasing distance from the orifice—close to the orifice the coating has a homogeneous, non-zero coverage, outside of the pattern the coverage is zero—the coverage in that example does not decrease gradually. The advantage of the gradual decrease in coverage is that a driving force for a droplet of marking material to move, said driving force being provided by the continuous wetting gradient provided by the coating according to the present invention, is present throughout the coated surface and not only on a border of a coated and a non-coated area of a surface. In the coating according to the present invention, the coating is distributed to the surface randomly.

From EP 2 072 261, a coating is known that has a coverage of coating that gradually decreases with increasing distance from the orifice. However, that coating is a patterned coating. The coating providing the wetting gradient according to EP 2 072 261 is applied by applying a pre-determined pattern of a first compound to the orifice surface. A second compound is subsequently bond to the first compound applied on the orifice surface, thereby forming a coating on the orifice surface. The pattern is consequently provided as a pattern. The pattern is a pre-determined pattern. To apply this pattern, the first compound has to be applied on predetermined positions on the orifice surface. Bonding of the second compound to the first compound provides a coating on the orifice surface. The predetermined pattern yields a wetting gradient on a macroscopic scale. However, on a microscopic scale, the patterns consist of islands having a homogeneous, non-zero coverage of coating. These islands having a homogeneous coverage of coating are alternated by regions having no coating at all. Consequently, the coating providing the wetting gradient according to EP 2 072 261 does not provide the wetting gradient on a microscopic scale.

The coating according to the present invention, on the other hand, is applied to the orifice surface in a random fashion. The orifice surface may be regarded as a surface, comprising a certain number of places to which a compound for forming the coating may bond. A place to which a compound for forming the coating may bond, may be for example an atom or a group of atoms, to which the compound may bond. For example, if the orifice surface is a silicon surface, the place, to which the compound may bond may be a silicon hydroxide group. If the orifice surface is a layer of gold atoms, the place to which a compound, for example a thiol compound, may bond is a gold atom. If a compound is bond to every place to which a compound may bond, the maximum coverage of the surface is reached and a monolayer is formed. However, it is also possible to bond a compound to only a certain percentage of the places to which a compound may bond. In the coating according to the present invention, the percentage of places to which a compound has bond, decreases with increasing distance from the orifice. However, the specific places to which a compound bonds and to which no compound bonds are divided randomly. As a consequence, in the coating according to the present invention, there are no regions having a homogeneous coverage of coating alternated by regions having a zero coverage of coating. Instead, there is a random distribution of the coating on the orifice surface. Therefore, a gradient is not only provided on a macroscopic scale, but also on a microscopic scale.

Because the coating is randomly distributed, the coating may be e.g. applied to the orifice surface in a process, wherein the coating is statistically distributed on the orifice surface.

In an aspect of the invention, a method for applying a wetting gradient on an orifice surface is provided, the method comprising the steps of:
a) providing a compound for forming a coating on the orifice surface;
b) locally bonding the compound to the orifice surface, thereby forming a coating for providing a wetting gradient to the orifice surface,
wherein in step b), the amount of the compound that locally bonds to the orifice surface is controlled, thereby controlling the local coverage of the coating, such that the local coverage is highest close to the orifice, and the local coverage decreases gradually with decreasing distance from the orifice and such that the coating is distributed randomly.

In the present invention, a wetting gradient is applied on an orifice surface in a two-step procedure. In order to form a coating on the orifice surface, a compound for forming the coating on the orifice surface may be required. In the first step of the procedure in accordance with the present invention, a compound for forming the coating on the orifice surface is provided.

In the second step of the procedure the compound is locally bond to the orifice surface, thereby forming a coating for providing a wetting gradient to the orifice surface. The amount of compound that locally bonds to the orifice surface is locally controlled such that the local coverage is highest close to the orifice, and the local coverage decreases gradually with decreasing distance from the orifice and such that the coating is distributed randomly. Provided that the compound is selected to provide wetting or anti-wetting property to the marking material to be used, a wetting gradient may be provided in accordance with the present invention.

In an embodiment, in step a), the orifice surface is arranged to be in contact with a medium comprising the compound for forming a coating on the orifice surface; and in step b), the orifice surface is locally irradiated through the medium with electromagnetic radiation, thereby locally supplying energy to the orifice surface and the compound to enable the orifice surface and the compound to locally bond to form the coating on the orifice surface, wherein in step b) the method further comprises;
supplying a suitable amount of energy to the orifice surface and the compound such that locally a higher coverage of coating is obtained on the orifice surface by locally supplying a larger amount of energy.

In the first step, the orifice surface is arranged to be in contact with the medium comprising the compound for forming the coating on the surface. To form the coating on the orifice surface, the compound for forming the coating may need to be in contact with the orifice surface. The medium may be, for example, a liquid solution comprising the compound, wherein a suitable solvent is used to dissolve the compound. Alternatively, the medium may be a gas, wherein the compound for forming the coating is present in the gas phase. In any case, the medium should allow suitable contact with the orifice surface and allow transfer of the molecules of the compound towards the orifice surface.

In the second step, the orifice surface is locally irradiated through the medium with electromagnetic radiation, thereby locally supplying energy to the orifice surface and the compound to enable the orifice surface and the compound to locally bond to form the coating on the orifice surface. In order to locally form a coating on the orifice surface, the orifice surface and the compound for forming a coating have to bond. Energy is needed to form the bond. Therefore, energy has to be supplied to the orifice surface and the compound for forming the coating such that a bond between the orifice surface and the compound is formed locally and the orifice surface is locally provided with the coating. The energy is provided by irradiating with electromagnetic radiation, for example visible light, UV-light or IR radiation. The orifice surface is irradiated through the medium comprising the compound. As a consequence, energy is supplied to both the orifice surface and the compound, thereby providing the energy necessary for bonding the compound and the orifice surface. The medium may be selected suitably, such that not all energy is absorbed by the medium.

Zuilhof at al., Langmuir 2009, 25(19), 11592-11597 describes the formation of alkene-derived monolayers on silica surfaces. A silica surface is irradiated with light to react the silica with alkenes, that are present in the vicinity of the silica surface. Zuilhof at al. also describes the use of a mask to create patterns of monolayers on a silica surface. On the parts of the orifice surface that are covered by the mask no monolayer is formed, whereas a monolayer is formed on parts of the orifice surface that are not covered by the mask. However, even if the monolayer of alkenes would be a monolayer of anti-wetting material, then the monolayer would still not provide a wetting gradient.

In the second step, a suitable amount of energy is supplied to the orifice surface and the compound such that locally a higher coverage of coating is obtained on the orifice surface by locally supplying a larger amount of energy. Energy is provided to form the bond between the orifice surface and the compound for forming the coating. By controlling an amount of energy, the quantity of compound that bonds to the orifice surface may be controlled. If a larger amount of energy is supplied, a larger quantity of compound may bond to the orifice surface, providing a higher coverage of the coating on the orifice surface. If a smaller amount of energy is supplied, a smaller quantity of compound may bond to the orifice surface, providing a lower coverage of the coating to the orifice surface. Hence, by locally supplying a larger amount of energy, locally a higher coverage of coating may be obtained. Provided that the compound is selected to provide wetting or anti-wetting property to the marking material to be used, a wetting gradient according to the present invention may be provided.

The amount of energy supplied to the orifice surface by irradiation may be controlled by controlling the wave length of the electromagnetic radiation. The energy of a photon of electromagnetic radiation is related to the wavelength of the radiation:

$$E = \frac{hc}{λ}$$

wherein E is the energy of the photon, h (Planck's constant) and c (speed of light) are constants and wherein λ is the wavelength of the electromagnetic radiation. Therefore, the amount of energy supplied may be controlled by supplying electromagnetic radiation of a suitable wavelength. For example, UV radiation has a higher energy than visible light, and visible light has a higher energy than IR radiation. Of course, any wavelength used in the method should at least be suited to bond the compound and the surface to a certain extend. Since not each and every wavelength may be absorbed by the compound and/or surface, the wavelengths should be selected corresponding to the materials used.

In an embodiment, an amount of energy is supplied close to the orifice and a smaller amount of energy is supplied at a larger distance from the orifice. The smaller the amount of energy supplied to the orifice surface, the less compound bonds to the orifice surface and the lower is the coverage of the coating applied to the orifice surface. Therefore, in this embodiment, the coverage of the coating is highest close to the orifice. If the coating is an anti-wetting coating and the coating is applied to the orifice surface, the orifice surface close to an orifice has a low wettability. At a larger distance from the orifice, the orifice surface is provided with a lower coverage of the coating. In case of an anti-wetting coating, the orifice surface further away from the orifice has a higher wettability. Consequently, a fluid present on the orifice surface, for example a droplet of marking material, experiences a wetting gradient and flows away from the orifice.

In an embodiment, the source of electromagnetic radiation produces a beam of electromagnetic radiation, said beam having a non-uniform intensity profile, wherein the beam is directed to an orifice and wherein the radiation is most intense at a position of the orifice. A source of electromagnetic radiation may generate a beam of radiation. The beam may have a non-uniform intensity profile, wherein more radiation is emitted in one direction and less radiation is emitted in another direction. If a beam of electromagnetic radiation having a non-uniform intensity profile is used to irradiate the orifice surface and the compound for forming the coating, the amount of energy supplied may differ for various parts of the orifice surface. If the highest intensity is directed to the orifice, the radiation is most intense at a position of the orifice and it may decrease with increasing distance from the orifice. As a consequence, a wetting gradient may be provided around an orifice by radiating an orifice surface with a beam of electromagnetic radiation, the beam being directed to the orifice.

Alternatively, the wetting gradient may be provided by radiating an orifice surface with a plurality of beams of electromagnetic radiation, wherein the beams of electromagnetic radiation show interference, such as constructive interference, providing an non-uniform intensity profile of the energy supplied to the orifice surface.

In an embodiment, the beam is a laser beam and a lens is placed between the source of the laser beam and the orifice surface to diverge the beam and to provide a larger amount of energy close to an orifice and a smaller amount of energy away from the orifice. A leaser beam is a beam that is usually non-divergent; radiation is emitted in one direction only. Hence, by irradiating using a laser beam, energy is supplied to one specific point on the orifice surface only. However, if a lens is placed in between the source of the laser and the orifice surface, the laser beam passes the lens and the beam may be diverged, such that not only one specific point, but a larger area of the orifice surface is irradiated. The amount of energy supplied may differ for each point in the area, such that locally, for example, close to an orifice, a larger amount of energy is supplied. Locally supplying a larger amount of energy to the orifice surface may result in the formation of a coating on the orifice surface, locally having a higher coverage.

In an embodiment, a mask is used to expose an area of the orifice surface to radiation. A mask may be placed between the source of electromagnetic radiation and the orifice surface. The mask may be in contact with the orifice surface or may not be in contact with the orifice surface. The mask may expose an area of the orifice surface to be irradiated and prevent another area from irradiation. When irradiation of an area of the orifice surface is prevented, no energy may be supplied to the orifice surface and no bond may be formed between the orifice surface and the compound. As a consequence, no coating is applied on the area of the orifice surface, that is covered by a mask. However, a mask may not only be used to create an orifice surface that is divided into predetermined sections, the sections either being provided with the coating or not being provided with the coating. Instead, a mask may also be used to provide an orifice surface that is locally provided with a higher coverage of coating and that is locally provided with a lower coverage of coating, such that a wetting gradient may be provided on the orifice surface. Additionally, the orifice surface may locally not be provided with any coating. The formation of a wetting gradient on the orifice surface by using a mask will be explained in more detail with reference to the below mentioned embodiments.

In a further embodiment, the amount of energy supplied to the orifice surface is controlled by using at least a first and a second mask, wherein the first mask is used to expose a first area of the orifice surface to radiation and wherein the second mask is used to expose a second area of the orifice surface to irradiation and wherein the amount of energy supplied to the first area of the orifice surface differs from the energy supplied to the second area of the orifice surface. A plurality of masks may be used to provide the orifice surface with wetting gradient. A first mask is used to expose a first area of the orifice surface to irradiation. As a consequence, a first coverage of coating is applied to the first area of the orifice surface. Now, the first area of the orifice surface is provided with the coating, whereas the other parts are not provided with the coating. However, no wetting gradient is provided yet on the orifice surface. To convert the area provided with the coating into an area with a wetting gradient, at least a second mask is employed in this embodiment. By using a second mask for exposing a second area of the orifice surface to irradiation and irradiating the surface, after a first coverage of coating has been applied to the first area of the orifice surface, a second coverage of coating is applied to the second area of the surface. The second area at least partially overlaps with the first area. The second area may be smaller than the first area. In that case, the part of the first area that does not overlap with the second area is only provided with a first coverage of coating. The part of the first area that overlaps with the second area of the orifice surface is provided with a second coverage of coating, the second coverage being higher than the first coverage. Provided that the coating is selected to provide either wetting or anti-wetting property to the marking material, a wetting gradient may thus be provided. The difference in coverage of coating of the different areas of the orifice surface provides a difference in wettability for the different areas of the orifice surface. Thus, a driving force may be generated for a droplet of marking material to move from one area of the orifice surface to another area of the orifice surface. Alternatively, the second area may be larger than the first area. In that case, the first area is provided with a larger coverage of coating than the part of the second area that does not overlap with the first area. Also in this case, a wetting gradient may be provided on the orifice surface. Optionally, a third, fourth, fifth, etc. mask may be used to expose a corresponding third, fourth, fifth, etc area of the orifice surface to irradiation and to apply a third, fourth, fifth, etc coverage of coating to the third, fourth, fifth, etc area of the orifice surface, wherein the respective areas of the orifice surface at least partially overlap. The more masks are used, the smoother the wetting gradient that is obtained. Moreover, the smaller the difference in size and position between two areas of the orifice surface, the smoother is the wetting gradient. The different areas (first, second, etc) may be positioned concentrically around an orifice.

In a further embodiment, the amount of energy supplied to the orifice surface by irradiation is controlled by means of optical transmission properties of the mask. A mask, used to expose an area of the orifice surface to irradiation may absorb or reflect all radiation, such that no radiation is supplied to the orifice surface covered by the mask. Alternatively, the mask may have optical transmission properties, such that a predetermined part of the radiation is able to pass through the mask and is thus supplied to the orifice surface. The amount of energy supplied to the orifice surface may be controlled by using a mask having optical transmission properties that enable the formation of a wetting gradient. For example, a semi-transparent mask may be used. By locally varying the optical properties of the semi-transparent mask, the amount of energy that is locally supplied to the orifice surface may be controlled. Alternatively, a mask may be used that is partially non-transparent and partially semi-transparent.

In a further embodiment, at least two of the mask, the orifice surface and the source of electromagnetic radiation move relative to one another. In this embodiment, a mask is used to expose an area of the orifice surface to irradiation. By moving at least two of the mask, the orifice surface and the source of electromagnetic radiation relative to one another, a local exposure time, i.e. a period during which each location is exposed to radiation, may be controlled. As a consequence, each location receives a predetermined amount of energy determined by the exposure time and hence, a local coverage of coating corresponds to the local exposure time.

In a particular embodiment, the amount of energy supplied to the orifice surface by irradiation is controlled by moving at least one of the mask, the orifice surface and the source of electromagnetic radiation with varying velocity. By moving at least one of the mask, the orifice surface and the source of electromagnetic radiation, at least two of the mask, the orifice surface and the source of electromagnetic radiation move relative to one another. As a consequence, the local exposure time may be controlled and may be different for different parts of the orifice surface. For example, by moving with predetermined, different velocities, the local exposure time for a first part of the orifice surface may be a longer period of time than the exposure time for a second part of the orifice surface. This results in a larger amount of energy being supplied to the first part of the orifice surface than to the second part of the orifice surface. As a consequence, a higher coverage of coating is applied to the first part of the orifice surface than to the second part of the orifice surface and a wetting gradient may be provided.

In a further embodiment, the amount of energy supplied to the orifice surface is controlled by using at least a first and a second mask, wherein the first mask is used to expose a first area of the orifice surface to radiation and wherein the second mask is used to expose a second area of the orifice surface to irradiation and wherein the two masks are moved in opposite direction. The part of the surface that is not exposed to radiation by the mask is prevented from radiation. However, in case two masks are used, a part of the surface is only exposed to radiation if it is not prevented from radiation, neither by the first mask nor by the second mask. For example, if the first area of the surface is not prevented from radiation by the first mask, but is prevented from radiation by the second mask, then the first area is not exposed to radiation. Alternatively, if the second area of the surface is not prevented from radiation by the second mask, but is prevented from radiation by the first mask, then the second area is not exposed to radiation. Since the two masks are moved, the area exposed to radiation and the area prevented from radiation change with time. At a certain moment in time, the first and second area start overlapping, i.e.: at that moment, a part of the orifice surface is not prevented from radiation by either of the first and the second mask and the area is exposed to radiation. At that moment, a relatively small part of the surface is irradiated. Upon further movement of the mask, the area that is irradiated becomes larger and consequently, a larger area is irradiated. When the masks are moved even further, the area of the surface exposed to radiation decreases again and a smaller part of the surface is exposed to radiation. As a consequence, the part of the surface that is irradiated when the first and the second area start overlapping and the area that is irradiated when the first and the second area nearly stop overlapping, are irradiated for a longer time than the area that is exposed only when the exposed area has reached a maximum size. Depending on the size of the first and the second area and on the relative speed of the first and the second mask, the part of the surface that is irradiated when the first and the second area start overlapping and the area that is irradiated when the first and the second area nearly stop overlapping, may overlap. Thus, locally, the surface is irradiated for a longer period of time and therefore, locally, a higher coverage of coating may be applied on the surface. Preferably, the part of the surface that is irradiated longest, may be the position of the orifice on the orifice surface. In that case, a part of the surface close to the orifice is irradiated longer and a higher coverage of coating is applied to the part of the surface close to the orifice. In summary, by using two masks that are moved in opposite directions, locally, the orifice surface may be irradiated for a longer time and a larger amount of energy may be supplied to the orifice surface. As a consequence, locally a higher coverage of the coating may be obtained.

In an embodiment, the coating applied in accordance with the steps a) and b) is a first coating, the method further comprising applying a second coating at a part of the orifice surface not coated with the first coating, and wherein one of the first and second coating is a wetting coating and the other one of the first and second coating is an anti-wetting coating. After applying the first coating to the orifice surface in accordance with the present invention, not the entire orifice surface may be coated with the first coating. The first coating may be either a wetting or an anti-wetting coating. After the first coating has been applied, a second coating may be applied. The second coating may be either a wetting or an anti-wetting coating. By applying a second coating, the wetting gradient may be further improved. For example, in case the first coating is an anti-wetting coating and the coverage of the coating depends on the distance from the orifice, being highest close to the orifice, a wetting gradient is obtained and fluid tends to move away from the orifice. By applying a wetting coating on the parts of the orifice surface, not yet provided with a coating, fluid tends to move from the anti-wetting coating to the wetting coating and fluid is removed even further away from the orifice.

In a further embodiment, the second coating is applied by chemical vapor deposition. Chemical vapor deposition (CVD) is an efficient way to provide an area of the orifice surface, that is not provided with a first coating, with a second coating. The second coating has properties that differ from the properties of the first coating.

In an alternative embodiment, the orifice surface comprises at least one orifice, the orifice surface being in fluid communication with a reservoir through the orifice, wherein in step a)
the compound for forming the coating is provided in the reservoir, and wherein in step b)
the compound for forming the coating is evaporated, a vapour of the compound diffusing through the orifice and bonding to the orifice surface, thereby forming the coating, and wherein step b) further comprises:
controlling the evaporation of the compound such that the coating formed on the orifice surface provides a wetting gradient on the orifice surface.

In the first step, a compound for forming a coating is provided in the reservoir. The reservoir is in fluid communication with the orifice surface through the orifice. The compound may be dissolved in a suitable medium. The medium may be, for example, a solvent. In any case, the solvent should be inert towards the compound for forming the coating and towards the orifice surface. Suitable media are for example alkenes, such as octane, decane, but also different alkenes may be used as the medium. Alternatively, also other solvents may be applied, provided that they are inert towards the compound for forming the coating. However, it may not be necessary to dissolve the compound in a medium; instead, neat compound may be provided in the reservoir. The reservoir is at least partially filled with the medium comprising the compound for forming the coating, or with the neat compound for forming the coating because the compound is needed to form the coating on the orifice surface. The reservoir may be filled to such extend, that also the orifice is at least partially filled with the compound and/or medium. The reservoir and the orifice are in fluid communication and hence, at a certain point when filling the reservoir, the orifice will be partially filled, too. In any case, the orifice surface should not be provided with the medium comprising the compound or with the neat compound, because in that case, the compound will bond to the orifice surface forming a homogeneous coverage of compound on the part of the orifice surface that is provided with the medium and hence, no gradient will be obtained.

In the second step the compound for forming the coating is evaporated. The medium, comprising the compound for forming the coating may be evaporated as well, but this is not necessary. The compound, upon evaporation, diffuses through the orifice. After diffusing through the orifice, the compound for forming the coating diffuses away from the orifice and thereby creates a gradient of concentration in the vapour phase, whereby the concentration of the compound is highest close to the orifice. The compound for forming the coating and the material of the orifice surface are suitably selected, such that the orifice surface and the compound for forming the coating bond spontaneously (without the need of additional energy) under the conditions applied for conducting the method in accordance with the present invention.

In the second step, the coating is formed on the orifice surface upon bonding of the compound for forming the coating to the orifice surface. The more compound for forming the coating bonds to the orifice surface, the higher is the coverage of the coating obtained. Because there is a gradient in concentration in the vapour phase of the compound for forming the coating and the concentration is highest close to the orifice, more compound bonds to the orifice surface at a position close to the orifice than to the orifice surface at a position further away from the orifice. Hence, the gradient in concentration in the vapour phase is transferred to the orifice surface and a higher coverage of coating is obtained close to the orifice, whereas a lower coverage of coating is obtained further away from the orifice. Provided that the compound is selected to provide wetting or anti-wetting property to the marking material to be used, a wetting gradient according to with the present invention may be provided. Please note that there is an upper limit to the coverage and supplying more compound by evaporating the compound does not lead to an even higher coverage. Therefore, the evaporation of the compound is suitably controlled, for example by controlling the temperature and pressure or by selecting a suitable compound for forming the coating. Moreover, by controlling parameters such as temperature, pressure and period of time during which the compound is evaporated, and by selecting a suitable compound for forming the coating, control is provided over the formation of the coating providing the wetting gradient to the orifice surface in accordance with the present invention. Moreover, by suitably controlling the environment in which the compound is evaporated, the occurrence of circumstances which may hamper the bonding of the compound for forming the coating to the orifice surface may be prevented. For example, the presence of contaminants, which may bond either to the orifice surface or to the compound, thereby preventing the bonding of the compound for forming the coating to the orifice surface may be prevented. This may be done, for example, by selecting a suitable medium or by selecting a suitable gas composition for forming the atmosphere surrounding the orifice surface and the reservoir.

In an embodiment, in step b)

an airflow is generated in a direction substantially parallel to the orifice surface to control the direction and the shape of the coating applied on the orifice surface around the orifice. After evaporation of the compound and diffusion of the compound through the orifice, the compound diffuses away from the orifice and bonds to the orifice surface. In this way, the gradient in concentration of the compound in the vapour phase is transferred to the orifice surface, creating a wetting gradient on the orifice surface. Absent any driving force, the compound will diffuse away from the orifice equally in all directions. Consequently, a wetting gradient will be obtained that is symmetrical with respect to the orifice. As a result, a droplet of fluid will experience an equal driving force to flow away from the orifice, irrespective of on which side of the orifice the droplet is located. However, in some cases, it may be preferred to have a wetting gradient that is stronger in one direction, than in another direction. For example, if the orifice surface of a print head in a printing device is placed in a vertical position, gravity provides an additional driving force for a droplet of fluid to move. To compensate for this additional driving force, the wetting gradient around the orifice may be adapted by adapting the shape of the coating applied on the orifice surface to provide a gradient that is stronger on one side of the orifice than on another side of the orifice. This object may be achieved by generating an airflow substantially parallel to the orifice of the surface in step b) of the method. Compound present in the vapour phase experiences a driving force to move in the direction of the airflow. The combination of the diffusion process and the airflow, which together provide the driving forces for the compound to move in the vapour phase results in the formation of a wetting gradient, wherein the distance between the orifice and the edge of the gradient is smaller in a direction downstream with respect to the airflow than in a direction upstream with respect to the airflow. Thus, the gradient will be stronger in one direction than in another direction. It will be clear to the person skilled in the art that the airflow may alternatively be a flow of inert gas. In any case, the composition of the gas phase should not hamper the bonding of the compound to the orifice surface.

In an embodiment, in step a), a layer of porous material is placed on the orifice surface to control the diffusion of the compound. The diffusion of the compound in the vapour phase will be different, respective of whether the compound diffuses through a gas or diffuses through a porous material. In a porous material, there are small channels and cavities within the material. The compound for forming the coating, once it has entered into the channel or the cavity of the porous material, diffuses through these channels and cavities. Hence, the porous material influences the diffusion process. As a result, the distance over which the compound diffuses in the vapour phase may be suitably controlled by placing a layer of porous material on the orifice surface, thereby controlling the area over which the wetting gradient extends on the orifice surface. Not only the channels within a layer of material may influence the diffusion process, also the surface conditions, in particular the roughness of the surface of said layer, may influence the diffusion.

In an embodiment, in step b), the pressure in the reservoir is reduced to improve evaporation of the compound for forming the coating. Generally, the volatility of a compound increases with decreasing pressure. Hence, by lowering the pressure in the reservoir, the compound for forming the coating will evaporate quicker and consequently, the orifice surface can be provided with a coating in a shorter period of time.

In an embodiment, in step b), the temperature of the compound for forming the coating is controlled to improve control over the evaporation of the compound for forming the coating. The higher the temperature, the higher is the rate of evaporation of the compound. Consequently, more compound evaporates and more compound may bond to the orifice surface for forming the coating. Alternatively, the compound may be cooled. Upon cooling of the compound, evaporation of the compound will be slower. In case the evaporation is slower, it may be easier to suitably control the evaporation of the compound and the subsequent formation of the coating on the orifice surface.

In an embodiment, the orifice surface and the reservoir for containing the compound are placed in a closed environment. It is important to control the relevant parameters, such as temperature, pressure, presence of water vapour, etc., in the environment of the reservoir and the orifice surface to thereby control the evaporation of the compound and the formation of the wetting gradient on the orifice surface. By placing the orifice surface and the reservoir for containing the compound in a closed environment, the environment may be suitably controlled. Thus, parameters such as pressure and temperature may be suitably controlled. Also presence of water may be prevented and/or the presence of gasses, such as oxygen may be prevented by placing the orifice surface and the reservoir in a closed environment. For example, oxygen and/or water may react with the orifice surface or the compound for forming the coating, thereby preventing the orifice surface and the compound to bond. If the orifice surface and the compound do not bond, no coating is provided on the orifice surface and hence, no wetting gradient is generated. By placing the orifice surface and the reservoir in a closed environment, the environment may be controlled, thereby providing better control over the formation of the wetting gradient on the orifice surface.

In an embodiment, the reservoir is formed by at least a second surface and the method further comprises
c) removing the coating from the second surface of the orifice plate.

The orifice surface, comprising at least one orifice, is arranged at a second end of the orifice. At a first end of the orifice the reservoir is arranged. The reservoir may be for example the ink channel of a print head. Alternatively, the reservoir may be formed by a vessel and by an orifice plate, the orifice plate being positioned on top of the vessel and the vessel being adapted to contain the medium comprising the compound. In any case, the reservoir comprises a second surface. The second surface may be for example a surface of the orifice plate or may be a surface inside the ink channel of a print head. When the compound is evaporated the compound starts diffusing towards the orifice. Before it reaches the orifice, the compound may come into contact with the second surface and bond to the second surface, thereby forming a coating on the second surface. Also when the second surface is exposed to the medium comprising the compound or to the neat compound, the compound may bond to the second surface. It may be preferred to remove the coating from the second surface after providing the orifice surface with a wetting gradient. For example, if the coating provides the second surface with anti-wetting properties, the anti-wetting properties of the second surface may negatively influence the jetting performance of the orifices.

In a particular embodiment, the coating is removed from the second surface by etching. The coating may be efficiently removed from the second surface by etching, for example using an etching solution or a plasma. The wetting gradient should not be removed and therefore, it is preferred to protect the wetting gradient on the orifice surface from being etched, for example by using a protective layer, which may be removed after etching. The protective layer may be a layer of tape, for example PVC tape. Optionally, the second surface may be selectively exposed to etching. In the latter case, protecting the wetting gradient may not be necessary.

In a particular embodiment, the coating is removed from the second surface using a laser beam. A laser beam is a suitable means to remove the coating from the second surface. To prevent the wetting gradient from being removed by the laser beam, the laser beam may be suitably directed to not irradiate the orifice surface provided with the wetting gradient. In an alternative embodiment, an intense light beam may be used instead of a laser beam.

In an embodiment, the compound for forming the coating comprises a Si—Cl bond. A Si—Cl bond generally is a reactive bond. Hence, the compound for forming the coating comprising a reactive Si—Cl bond may bond spontaneously to the orifice surface by chemically reacting with the surface, thereby providing the orifice surface with a coating.

In a particular embodiment, the compound for forming the coating is a trichlorosilane compound.

In an embodiment, orifice surface consists of a material, the material being selected from the group of silicon, silica, Ni or metal-coated Ni. An orifice surface, which may be part of for example, an orifice plate or a print head often comprises Ni or a metal-coated Ni, such as Ni coated with a gold layer. Alternatively, the orifice surface may comprise silicon. Silicon comprises Si—OH bonds. These bonds are reactive, for example towards Si—Cl bonds. Thus, by suitable selecting the compound for forming the coating and the material of which the orifice surface consists, for example a silicon orifice surface and a compound comprising a Si—Cl bond, the compound may bond to the orifice surface spontaneously, thereby providing the orifice surface with a coating.

In an embodiment, the coating applied in accordance with the steps a) and b) is a first coating, the method further comprising applying a second coating at a part of the orifice surface not coated with the first coating, and wherein one of the first and second coating is a wetting coating and the other one of the first and second coating is an anti-wetting coating. After applying the first coating to the orifice surface in accordance with the present invention, not the entire orifice surface may be coated with the first coating. The first coating may be either a wetting or an anti-wetting coating. After the first coating has been applied, a second coating may be applied. The second coating may be either a wetting or an anti-wetting coating. By applying a second coating, the wetting gradient may be further improved. For example, in case the first coating is an anti-wetting coating and the coverage of the coating depends on the distance from the orifice, being highest close to the orifice, a wetting gradient is obtained and fluid tends to move away from the orifice. By applying a wetting coating on the parts of the orifice surface, not yet provided with a coating, fluid tends to move from the anti-wetting coating to the wetting coating and fluid is removed even further away from the orifice.

In an embodiment, the second coating is applied by chemical vapor deposition. Chemical vapor deposition (CVD) is an efficient way to provide an area of the orifice surface, that is not provided with a first coating, with a second coating. The second coating has properties that differ from the properties of the first coating.

In an aspect of the invention, the present invention further comprises an ink jet printing device, the ink jet printing device comprising a print head provided with an orifice surface, the orifice surface having arranged therein an orifice and the orifice surface having a wetting gradient around the orifice, wherein the wetting gradient has been applied to the orifice surface by a method in accordance with the present invention.

In an aspect, the present invention further comprises a print head provided with an orifice surface, the orifice surface having arranged therein an orifice and the orifice surface having a wetting gradient around the orifice, wherein the wetting gradient has been applied to the orifice surface by a method in accordance with the present invention.

### BRIEF DESCRIPTION OF THE DRAWINGS

These and further features and advantages of the present invention are further explained hereinafter with reference to the accompanying drawings showing non-limiting embodiments and wherein:

FIG. 1A shows a schematic representation of an ink jet printing assembly;

FIG. 1B shows a schematic representation of an image forming apparatus;

FIG. 2 shows an example of a wetting gradient according to the present invention;

FIG. 3A illustrates a first embodiment of a method for applying a coating on an orifice surface in accordance with the present invention;

FIG. 3B illustrates a further embodiment of a method for applying a coating on an orifice surface in accordance with the present invention;

FIG. 4 illustrates a further embodiment of a method for applying a coating on an orifice surface in accordance with the present invention;

FIG. 5 illustrates a further embodiment of a method for applying a coating on an orifice surface in accordance with the present invention;

FIG. 6A-6C illustrate a further embodiment of a method for applying a coating on an orifice surface in accordance with the present invention;

FIG. 7A-7C illustrate a further embodiment of a method for applying a coating on an orifice surface in accordance with the present invention;

FIG. 7D shows an example of a gradient obtained by the method, illustrated in FIG. 7A-7C;

FIG. 8 illustrates a further embodiment of a method for applying a coating on an orifice surface in accordance with the present invention;

FIG. 9 illustrates a further embodiment of a method for applying a coating on an orifice surface in accordance with the present invention;

FIG. 10A-10D illustrate a further embodiment of a method for applying a coating on an orifice surface in accordance with the present invention;

FIG. 10E shows a schematic representation of the amount of energy supplied to the orifice surface, when applying the method illustrated in FIG. 10A-10D;

FIG. 11 shows an orifice surface, provided with a first coating and a second coating.

FIG. 12A illustrates a second embodiment of a method for applying a coating on an orifice surface in accordance with the present invention;

FIG. 12B illustrates an alternative embodiment of a method for applying a coating on an orifice surface in accordance with the present invention;

FIG. 12C illustrates a further alternative embodiment of a method for applying a coating on an orifice surface in accordance with the present invention;

FIGS. 13A-C illustrate a first embodiment of a method for removing a coating from a second surface of an orifice plate in accordance with the present invention;

FIGS. 14A-C illustrate a second embodiment of a method for removing a coating from a second surface of an orifice plate in accordance with the present invention;

FIG. 15 illustrates a further embodiment of a method for applying a coating on an orifice surface in accordance with the present invention;

FIG. 16 illustrates a further embodiment of a method for applying a coating on an orifice surface in accordance with the present invention;

FIGS. 17A and 17B illustrate a further embodiment of a method for applying a coating on an orifice surface in accordance with the present invention;

### DETAILED DESCRIPTION OF THE DRAWINGS

In the drawings like reference numbers refer to like elements.

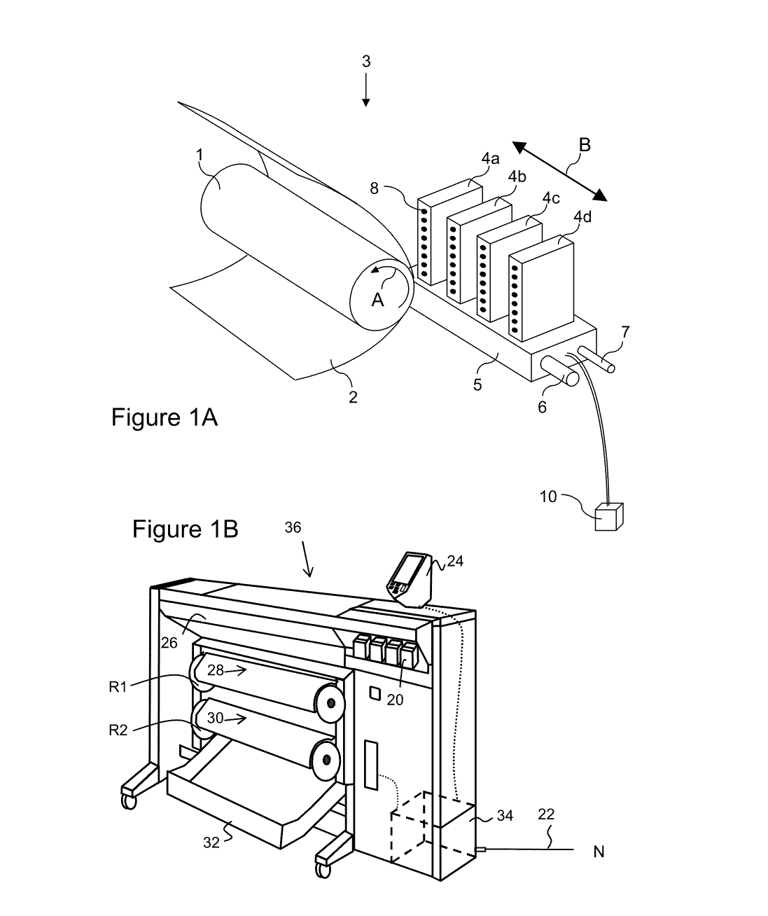

FIG. 1A shows an ink jet printing assembly 3. The ink jet printing assembly 3 comprises supporting means for supporting an image-receiving member 2. The supporting means are shown in FIG. 1A as a platen 1, but alternatively, the supporting means may be a flat surface. The platen 1, as depicted in FIG. 1A, is a rotatable drum, which is rotatable about its axis as indicated by arrow A. The supporting means may be optionally provided with suction holes for holding the image-receiving member in a fixed position with respect to the supporting means. The ink jet printing assembly 3 comprises print heads 4a-4d, mounted on a scanning print carriage 5. The scanning print carriage 5 is guided by suitable guiding means 6, 7 to move in reciprocation in the main scanning direction B. Each print head 4a-4d comprises an orifice surface, which orifice surface is provided with at least one orifice 8. The print heads 4a-4d are configured to eject droplets of marking material onto the image-receiving member 2. The carriage 5 as well as the print heads 4a-4d are driven by suitable driving means 10.

The image-receiving member 2 may be a medium in web or in sheet form and may be composed of e.g. paper, cardboard, label stock, coated paper, plastic or textile. Alternatively, the image-receiving member 2 may also be an intermediate member, endless or not. Examples of endless members, which may be moved cyclically, are a belt or a drum. The image-receiving member 2 is moved in the sub scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image-receiving member 2 in the main scanning direction B. Only four print heads 4a-4d are depicted for demonstrating the invention. In practice an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by guiding means 6,7. These guiding means 6,7 may be rods as depicted in FIG. 1A. The rods may be driven by suitable driving means (not shown). Alternatively, the carriage 5 may be guided by other guiding means, such as an arm being able to move the carriage. Another alternative is to move the image-receiving material 2 in the main scanning direction B.

Each print head 4a-4d comprises an orifice surface having at least one orifice 8, in fluid communication with a pressure chamber containing fluid marking material provided in the print head 4a-4d. On the orifice surface, a number of orifices 8 is arranged in a single linear array parallel to the sub scanning direction A. Eight orifices 8 per print head 4a-4d are depicted in FIG. 1A, however obviously in a practical embodiment several hundreds of orifices 8 may be provided per print head 4a-4d, optionally arranged in multiple arrays. As depicted in FIG. 1A, the respective print heads 4a-4d are placed parallel to each other such that corresponding orifices 8 of the respective print heads 4a-4d are positioned in-line in the main scanning direction B. This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of ink from the orifices 8.

Upon ejection of the marking material, some marking material may be spilled and stay on the orifice surface of the print head 4a-4d. The ink present on the orifice surface, may negatively influence the ejection of droplets and the placement of these droplets on the image-receiving member 2. Therefore, it may be advantageous to remove excess of ink from the orifice surface. The excess of ink may be removed for example by wiping with a wiper and/or by application of a suitable anti-wetting property of the surface, e.g. provided by a coating.

The carriage 5 and the print heads 4a-4d as well as the platen 1 are driven by driving means 10, which are schematically shown.

FIG. 1B shows an image forming apparatus 36, wherein printing is achieved using a wide format inkjet printer. The wide-format image forming apparatus 36 comprises a housing 26, wherein the printing assembly, for example the ink jet printing assembly shown in FIG. 1A is placed. The image forming apparatus 36 also comprises a storage means for storing image-receiving member 28, 30, a delivery tray 32 to collect the image-receiving member 28, 30 after printing and storage means for marking material 20. The wide-format image forming apparatus 36 furthermore comprises means for receiving print jobs and optionally means for manipulating print jobs. These means may include a user interface unit 24 and/or a control unit 34, for example a computer.

Images are printed on a image-receiving member, for example paper, supplied by a roll 28, 30. The roll 28 is supported on the roll support R1, while the roll 30 is supported on the roll support R2. Alternatively, cut sheet image-receiving members may be used instead of rolls 28, 30 of image-receiving member. Printed sheets of the image-receiving member, cut off from the roll 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the printing apparatus 36. The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be send to the printer via this USB port.

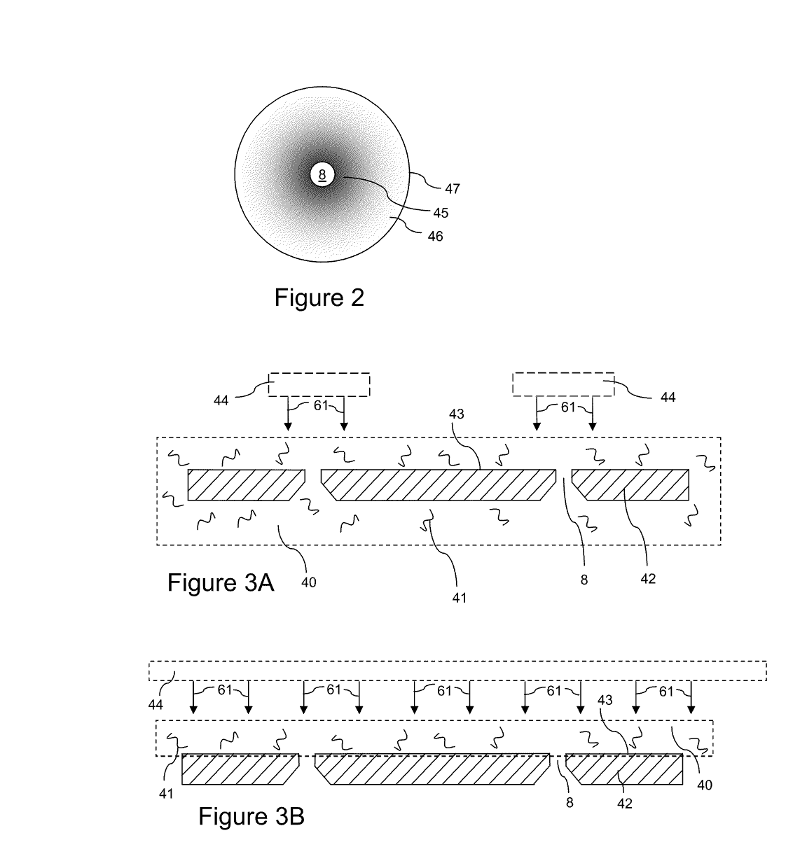

FIG. 2 shows an example of a wetting gradient, applied around the orifice 8 in accordance with the present invention. FIG. 2 is a top view of the orifice surface 43, comprising the orifice 8. Locally, a coating is supplied on the orifice surface 43 (not shown). The coating is supplied around the orifice 8. The compound 41, bonded to the orifice surface 43 for forming the coating is schematically shown. The more compound 41 bonded to the surface 43, the higher is the coverage of the coating; the higher the coverage of the coating, the darker is the area of the surface 43. The high coverage area 45, is therefore shown in black. In FIG. 2, this is the area surrounding the orifice 8. An area further away from the orifice 8, is a low coverage area 46. Even further away from the orifice 8, a virtual border 47 is present. Outside of the virtual border 47, remote from the orifice 8, no coating is present at all.

By using an anti-wetting coating as the coating, a wetting gradient is generated, wherein the high coverage area 45 surrounding the orifice 8 is anti-wetting. The wettability of the orifice surface 43 increases with increasing distance from the orifice 8 and in this way a wetting gradient is obtained.

FIG. 3A shows a cross-section of an orifice surface 43, comprising an orifice 8. The orifice surface 43 is arranged in contact with a medium 40, by suspending the orifice plate 42 in the medium 40. The medium 40 may be a liquid solution, for example. The medium 40 comprises a compound 41 for forming a coating on the orifice surface 43. The compound 41 does not bond to the orifice surface 43, unless energy is supplied to the orifice surface 43 and the compound 41. Energy may be supplied to the orifice surface 43 and the compound 41 by irradiating the orifice surface 43 using a source 44 of electromagnetic radiation, such as a lamp, a UV-lamp, a laser, etc. The source 44 of radiation is positioned such, that the medium 40 is between the beam of radiation produced by the source 44 and the orifice surface 43. The medium 40 is selected such, that radiation is at least not completely absorbed by the medium 40, such that at least a sufficient part of the radiation reaches the orifice surface 43. The orifice surface 43 may be irradiated locally. By locally irradiating the orifice surface 43, energy is locally supplied to the orifice surface 43 and the compound 41. By locally supplying energy to the orifice surface 43 and the compound 41, locally a bond is formed between the orifice surface 43 and the compound 41 and locally a coating is formed. The coverage of a coating, i.e. the amount of compound 41 that is locally bonded to the orifice surface 43, may vary depending on the amount of energy that is locally supplied to the orifice surface 43. For example, if a large amount of energy is supplied to the orifice surface 43 close to the orifice 8, a high coverage of coating is formed close to the orifice 8. If a small amount of energy is supplied to the orifice surface 43 further away from the orifice 8, a lower coverage of coating may be formed further away from the orifice 8. Please note that there is an upper limit to the coverage and supplying more energy than required to provide such a maximum coverage does not lead to an even higher coverage.

Please note that, although a cross-section of the orifice plate 42 is shown, a print head does not necessarily comprise the orifice plate 42. Alternatively, print head may not comprise the orifice plate 42, for example in case the print head is formed out of one piece, but the print head still comprises an orifice surface 43. It will be clear to the person skilled in the art that the present invention is also applicable to print heads that comprise such an orifice surface 43, but do not comprise the orifice plate 42.

FIG. 3B shows a cross-section of the orifice plate 42, comprising the orifice 8. The orifice surface 43 of the orifice plate 42 is arranged in contact with a medium 40, whereas other surfaces of the orifice plate 42 are arranged not in contact with the medium 40. The orifice surface 43 may be locally irradiated by a source 44 of electromagnetic radiation, like explained above with reference to FIG. 3A.

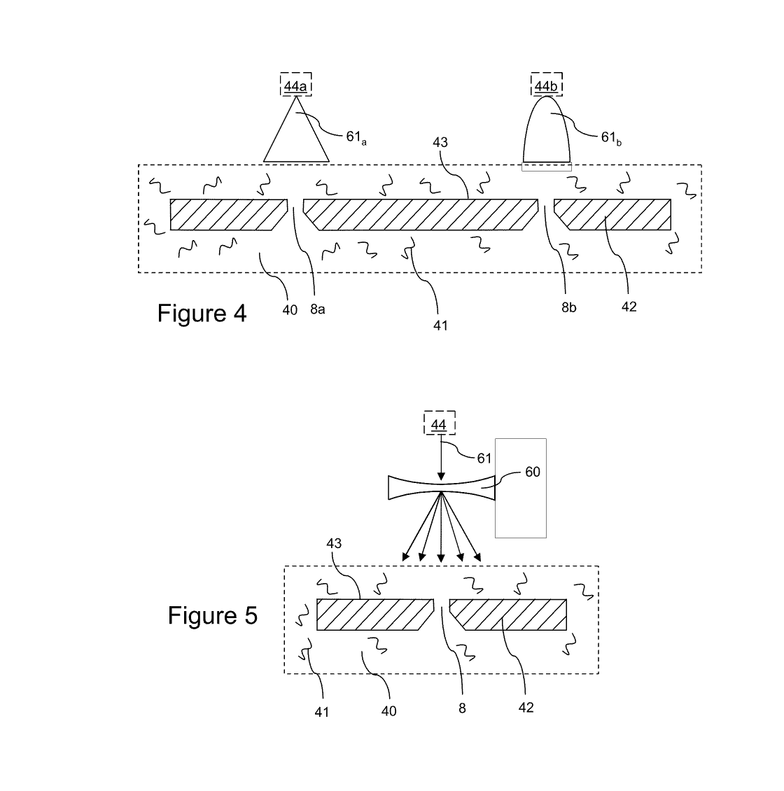

FIG. 4 shows a cross-section of the orifice plate 42, comprising the orifice surface 43, wherein the orifice surface 43 is irradiated by sources 44a, 44b of electromagnetic irradiation that produce a beam 61ₐ, 61_{b} having a non-uniform intensity profile. Alternatively, only one or more than two sources of radiation may be used to irradiate the orifice surface 43. The beams 61ₐ, 61_{b} are most intense in the center of the beam. The beam 61ₐ, 61_{b} is directed to orifices 8a, 8b, respectively, such that the part of either of the beams 61ₐ, 61_{b}, that is most intense is directed to the orifice 8a, 8b. The orifice surface 43 is arranged to be in contact with the medium 40 comprising the compound 41 for forming the coating. A first source 44a of electromagnetic radiation is placed above the orifice surface 43. The source 44a produces the beam 61ₐ having a conical shape. The beam 61ₐ is most intense in a position above the orifice 8a. The second source 44b of electromagnetic radiation is placed above the orifice surface 43. The source 44b produces the beam 61_{b} having a non-linear intensity profile, different from the intensity profile of the source 44a. The beam 61_{b} is most intense in a position above the orifice 8b. Alternatively, a source having any other suitably selected intensity profile, such as a Gaussian intensity profile, may be used to supply energy to the orifice surface 43.

The part of the orifice surface 43 that is closest to the orifice 8, is supplied with the largest amount of energy. Therefore, more compound 41 for forming the coating bonds to the orifice surface 43 at a position close to the orifice 8 and a higher coverage of coating is obtained at a position close to the orifice 8. If the coating has either wetting properties or anti-wetting properties, a decrease of the coverage of the coating with increasing distance from the orifice 8 results in the generation of a wetting gradient around the orifice 8. Application of an anti-wetting coating around the orifice 8 generates such a wetting gradient, that a driving force for marking material to flow away from the orifice 8 is provided. On the other hand, application of a wetting coating around the orifice 8 generates such a wetting gradient, that a driving force for marking material to flow towards the orifice 8 is provided.

FIG. 5 shows a cross-section of the orifice plate 42 comprising the orifice surface 43. The orifice surface 43 is arranged to be in contact with the medium 40 comprising the compound 41 for forming the coating. A source 44 of electromagnetic radiation is positioned above the orifice surface 43. The source 44 in this embodiment is a laser beam. The laser emits a laser beam, the electromagnetic radiation of the laser beam having a certain wavelength. The laser beam is not divergent.

A lens 60 is placed between the source 44 of the laser beam and the orifice surface 43. The lens 60 diverges the laser beam. The divergent laser beam irradiates a part of the orifice surface 43. The laser beam may be diverged by the lens in such a way, that a higher radiation intensity is provided on a part of the orifice surface 43 close to the orifice 8 and a lower intensity is directed to a part of the orifice surface 43 further away from the orifice 8. This results in more energy being supplied to the part of the orifice surface 43 close to the orifice 8 and consequently, a higher coverage of coating is obtained on the part of the orifice surface 43 close to the orifice 8, as explained above. In an embodiment, the laser may have a transversal intensity profile, e.g. a Gaussian intensity profile. This means that the laser beam is most intense in the center of the beam. By aligning a laser beam to the center of the orifice 8, more energy is supplied to the part of the orifice surface 43 close to the orifice 8 and consequently, a higher coverage of coating is obtained on the orifice surface 43 close to the orifice 8. The laser beam having a transversal intensity profile may be used in combination with the lens 60 or may be used without the lens 60.

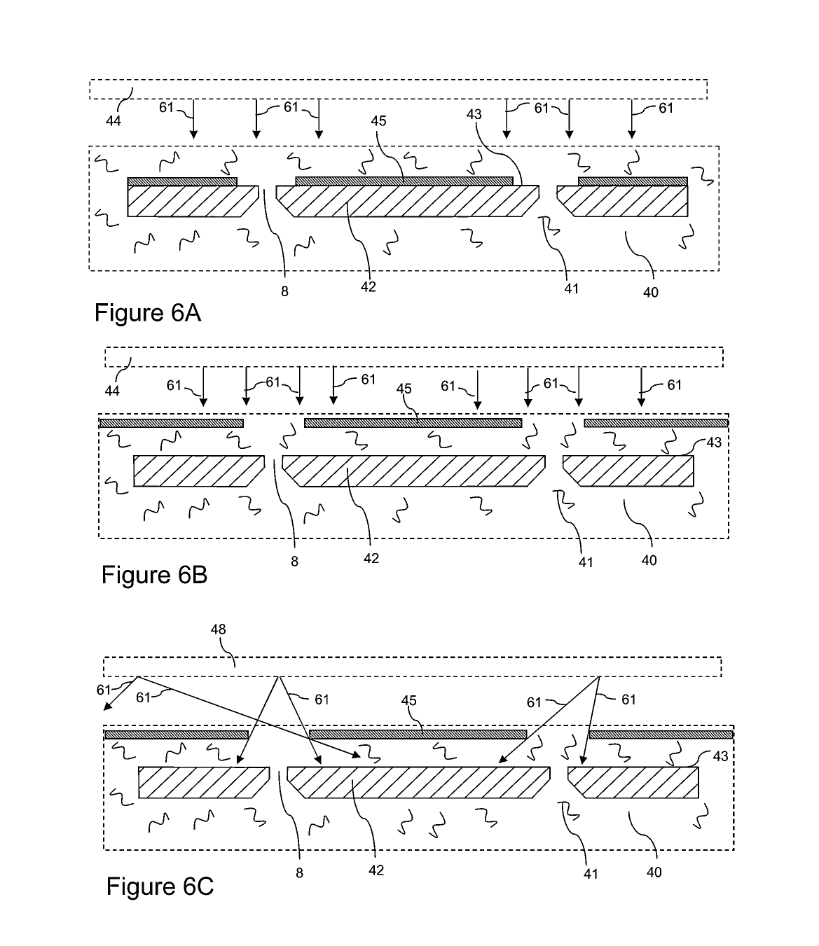

FIG. 6A-6C show a cross-section of the orifice plate 42 comprising the orifice surface 43, wherein the orifice surface 43 is arranged to be in contact with the medium 40, comprising the compound 41 for forming the coating. The source 44 of electromagnetic radiation is provided to supply an amount of energy to the medium 40 comprising the compound 41 and the orifice surface 43. A mask 45 is placed between the orifice plate 42 and the source 44 of electromagnetic radiation.

By placing the mask 45, only a part of the orifice surface 43 is exposed. The part of the orifice surface 43 covered by the mask 45 is not exposed to radiation, since radiation does not penetrate the mask 45. Since only a part of the orifice surface 43 is expose to radiation, energy is only supplied to an area of the orifice surface 43. Consequently, only locally a coating is formed on the orifice surface 43 by bonding of the compound 41 to the orifice surface 43. By suitably selecting the mask 45, a suitable area of the orifice surface 43 is exposed to radiation and a coating is formed on the suitable area of the orifice surface 43.

FIG. 6A shows the orifice plate 42, wherein the mask 45 is positioned on top of the orifice surface 43.

FIG. 6B shows the orifice plate 42, wherein the mask 45 is positioned above the orifice surface 43, without the mask 45 and the orifice surface 43 being into direct contact. Alternatively, the mask 45 may be placed in any position between the source 44 of electromagnetic radiation and the orifice surface 43. The mask 45 may be in contact with the medium 40 or may not be in contact with the medium.

FIG. 6C shows the orifice plate 42, wherein the mask 45 is positioned above the orifice surface 43, without the mask 45 and the orifice surface 43 being into direct contact. A source 48 of electromagnetic radiation is positioned, such that the mask 45 is positioned between the source 48 and the orifice surface 43. The source 48 is a homogeneous source of radiation that emits divergent beams 61 of radiation from all points within the source 48. Every point within the source 48 emits substantially the same amount of radiation. Since a mask 45 is used to cover a part of the orifice surface 43, only a part of the orifice surface 43 is provided with radiation. Because of the presence of the mask 45 and because of the divergence of the beams 61, more energy is supplied to a part of the surface 43 close to the orifice 8. Less energy is supplied to a part of the orifice surface 43 further away from the orifice 8. There may be parts on the surface 43 that are not irradiated at all. The amount of energy, locally supplied to the orifice surface 43, may be controlled e.g. by controlling the distance between the source 48 and the mask 45, by controlling the thickness of the mask 45, by controlling the distance between the mask 45 and the orifice surface 43, and/or by controlling the size and shape of the opening in the mask 45.

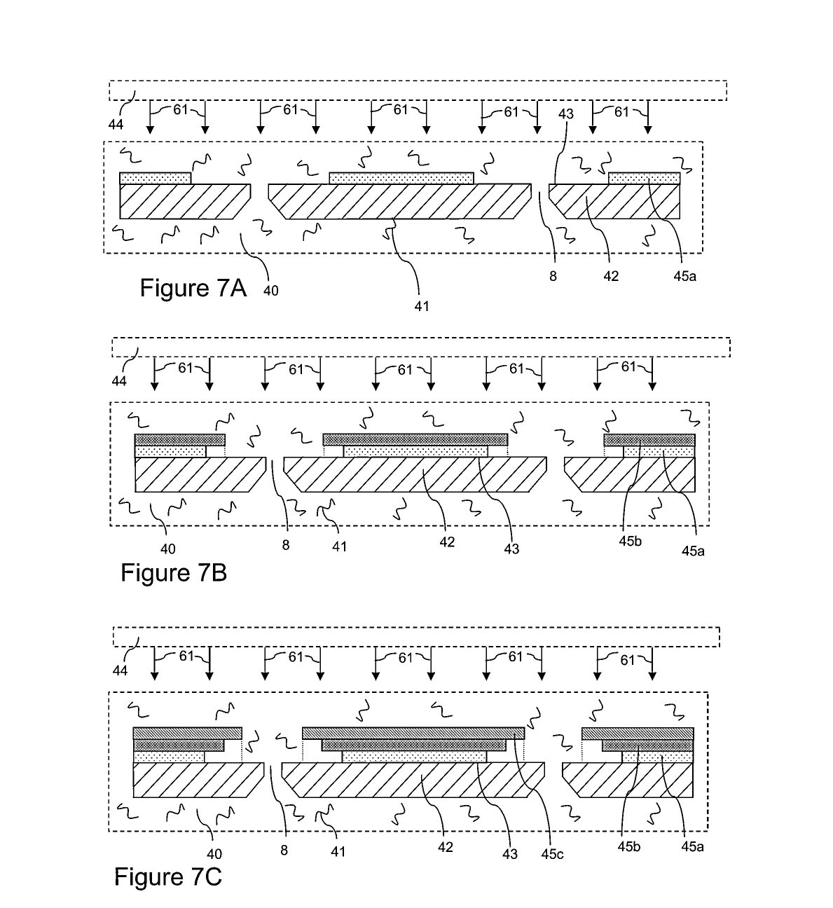

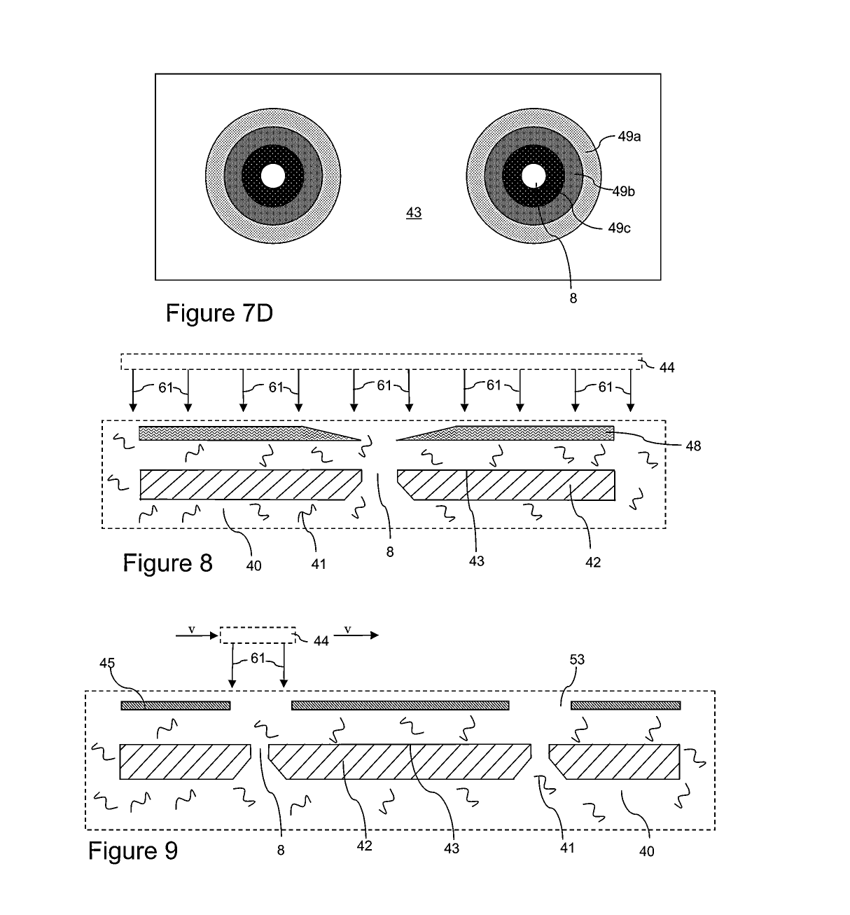

FIG. 7A shows a cross-section of the orifice plate 42 comprising the orifice surface 43, wherein the orifice surface 43 is arranged to be in contact with the medium 40, comprising the compound 41 for forming the coating. The source 44 of electromagnetic radiation is provided to supply an amount of energy to the medium 40 comprising the compound 41 and the orifice surface 43. A first mask 45a is placed between the orifice surface 43 and the source 44 of electromagnetic radiation. The first mask 45a exposes a first area of the orifice surface 43 to radiation. The first area of the orifice surface 43 is irradiated for a first time interval and consequently, a first amount of energy is supplied to the first area. Therefore, on the first area of the orifice surface 43, compound 41 bonds to the orifice surface 43, forming a coating, having a first density.

FIG. 7B shows a cross-section of the orifice plate 42 comprising the orifice surface 43, wherein the orifice surface 43 is arranged to be in contact with the medium 40, comprising the compound 41 for forming the coating. The source 44 of electromagnetic radiation is provided to supply an amount of energy to the medium 40 comprising the compound 41 and the orifice surface 43. A second mask 45b is placed between the source 44 of electromagnetic radiation and the orifice surface 43. The first mask 45a may be removed, but this is not necessary. The second mask 45b exposes a second area of the orifice surface 43 to radiation. The second area of the orifice surface 43 is exposed to radiation during a second time interval. During the second time interval, a second amount of energy is supplied to the surface 43. Consequently, a further amount of compound 41 may bond to the second area resulting in a higher density of the coating in the second area of the orifice surface 43.

FIG. 7C shows a cross-section of the orifice plate 42 comprising the orifice surface 43. Now, a third mask 45c is placed between the second mask 45b and the source 44 of radiation. The first mask 45a and/or the second mask 45b may be removed, but this is not necessary. The third mask 45c exposes a third area of the orifice surface 43 to radiation. The third area of the orifice surface 43 is exposed to radiation during a third time interval. During the third time interval, a third amount of energy is supplied to the orifice surface 43. Consequently, the compound 41 may bond to the third area of the surface, resulting in even higher density of the coating in the third area.

The first area, the second area and the third area of the surface 43 partially overlap. Since the second area partially overlaps the first area of the orifice surface 43, both a first and a second amount of energy are supplied to the area of the orifice surface 43, where the first and the second area overlap. Consequently, to this area of the orifice surface 43, where the first and the second area overlap, a first and a second coverage of coating are applied and the coverage of the coating is higher there than on an area of the orifice surface 43 where only a first coverage of coating is applied. Because the third area partially overlaps with the second area, a part of the orifice surface 43 is provided with a second and a third coverage of coating, or the third area may partially overlap with the first area, etc.

The first, second and third time interval may comprise the same amount of time or alternatively, the amounts of time may differ. The difference in coverage of coating obtained on the orifice surface 43 may be influenced by the time interval during which energy is supplied to the orifice surface 43. In an embodiment, the difference between the first, second and third coverage of coating may be controlled by controlling the time intervals, at which energy is supplied to a first, second and third area of the surface. By controlling the difference in coverage between the respective areas, the strength of the wetting gradient, may be controlled.

In an embodiment, the difference in coverage of the respective areas of the surface may be controlled by applying radiation of a suitable wavelength to each one of the first, second and third area.

FIG. 7D illustrates a wetting gradient, provided around the orifice 8 on the orifice surface 43, generated by subsequently applying energy to a first, second and third area of the orifice surface 43 by exposing the respective areas to radiation using a first, a second and a third mask, 45a, 45b, 45c, respectively, as is explained above with reference to FIG. 7A-7C. A first coverage of coating was applied to a first area 49a of the surface 43. Subsequently, a second coverage of coating 49b was supplied to the second area 49b of the orifice surface 43. The second area 49b partially overlaps with the first area 49a. As a consequence, a part of the first area 49a, provided with a first coverage of coating, was also provided with a second coverage of coating, resulting in an overall higher coverage. Finally, a third coverage of coating was supplied to the third area 49c of the orifice surface 43. The third area 49c partially overlaps with the first and the second area 49a, 49b. As a consequence, a part of the first area 49a, that overlaps with the second area 49b and the third area 49c, was provided with the first coverage of coating, with the second coverage of coating, and with the third coverage of coating. This results in the wetting gradient around the orifice 8 as shown in FIG. 7D. The closer the area is to the orifice 8, the higher is the coverage of the coating of such area. In case the coating is an anti-wetting coating, the gradient is most anti-wetting around the orifice 8 and provides a driving force for a droplet of marking material to move away from the orifice 8.

The application of a gradient, using three different levels of coverage is described here. Of course, it will be clear to the person skilled in the art, that any number of masks may be used to obtain a wetting gradient on a surface. The more masks are used, the smoother is the gradient obtained.

FIG. 8 shows a cross-section of the orifice plate 42 comprising the orifice surface 43, provided with at least one nozzle. The orifice surface 43 is arranged to be in contact with the medium 40 comprising the compound 41 for forming a coating. The source 44 of electromagnetic radiation is provided to supply radiation to the orifice surface 43 and the compound 41. A mask 48 is placed between the orifice surface 43 and the source of radiation 44. The mask 48 has optical transmission properties that are selected such that the mask locally absorbs a part of the radiation, i.e. the mask 48 is locally a semi-transparent mask 48. The amount of radiation absorbed by the mask 48 may depend on several parameters, for example wavelength of the electromagnetic radiation and the thickness of the mask 48. In the illustrated embodiment, the thickness of the mask 48 is small at a position close to the orifice 8. At a position away from the orifice 8, the mask 48 has a larger thickness. As mentioned above, the amount of radiation absorbed by the mask 48 may depend amongst others on the thickness of the mask 48: the thicker the semi-transparent mask 48, the more energy is absorbed by the mask 48 and the less energy is supplied to the orifice surface 43 and the compound 41 for forming the coating. Hence, the amount of energy supplied to the orifice surface 43 and the compound 41 may be controlled by controlling the thickness of the semi-transparent mask 48. As a consequence, locally more energy may be supplied to the orifice surface 43 by providing a semi-transparent mask 48 that locally has a smaller thickness, thereby locally forming a higher coverage of coating to the orifice surface 43 to create a wetting gradient, in case the coating has either wetting or anti-wetting properties. Of course, as mentioned above, in another embodiment, other features of the mask 48 may be controlled to provide local radiation transmission properties of the mask 48.

FIG. 9 shows a cross-section of the orifice plate 42 comprising the orifice surface 43, the orifice plate 42 being arranged to be in contact with the medium 40 comprising the compound 41 for forming a coating. The source 44 of electromagnetic radiation is provided to supply radiation to the orifice surface 43 and the compound 41. The mask 45 is placed between the orifice surface 43 and the source 44 of radiation. The source 44 of electromagnetic radiation is moved in a direction substantially parallel to the orifice surface 43. The source 44 of radiation is moved with a velocity v. Alternatively, the mask 45 or the orifice surface 43 may be moved. By moving one of the mask 45, the source 44 of radiation and the orifice surface 43, at least two of the mask 45, the source 44 of radiation and the orifice surface 43 move with respect to one another. This relative movement might also be obtained by moving two of the mask 45, the source 44 of radiation and the orifice surface 43.

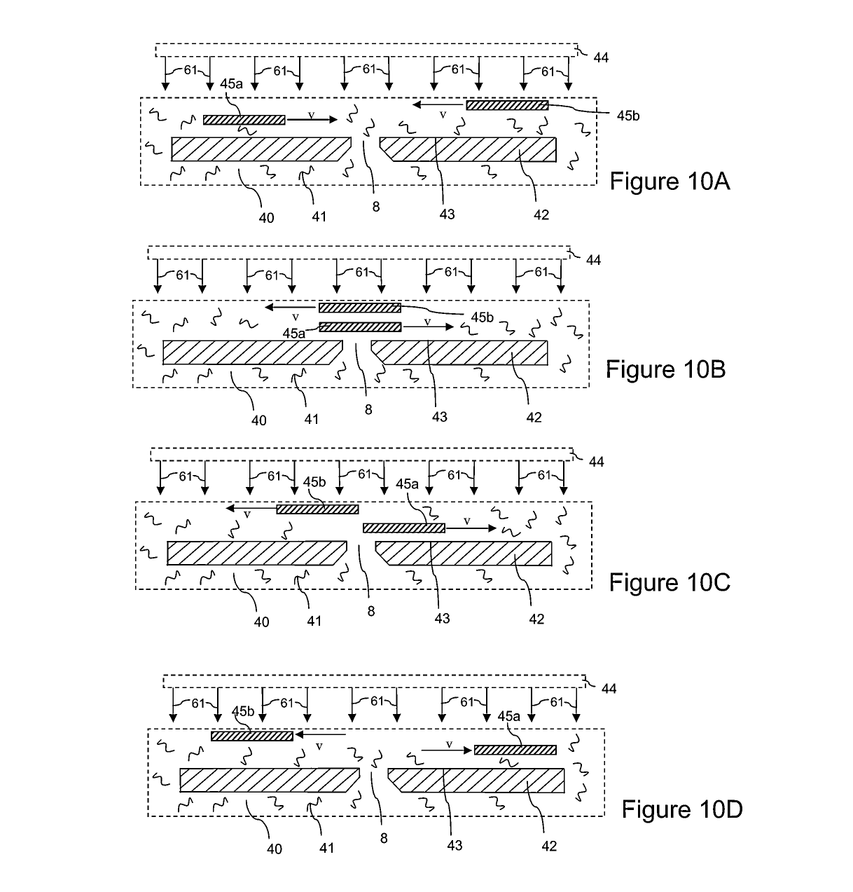

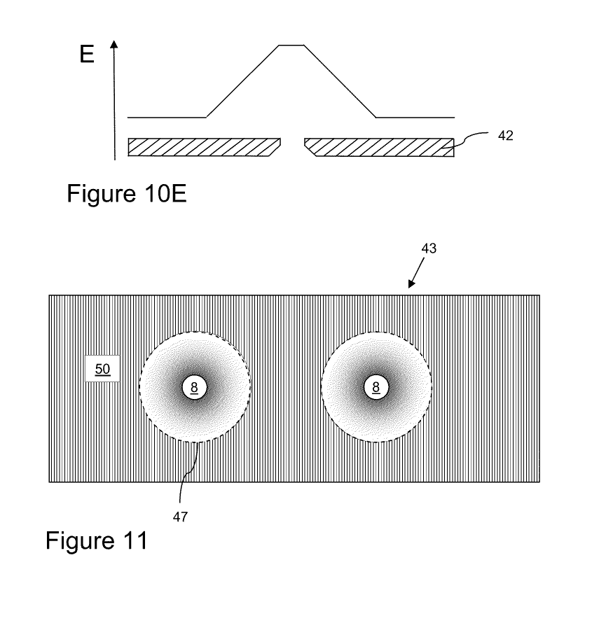

The mask 45 has an opening 53. A beam 61 of radiation, supplied by the source 44 of radiation is not impeded by the mask 45 in case the beam 61 travels through the opening 53 of the mask 45 and thus, energy may be supplied to the orifice surface 43 and to the compound 41 to bond and to thereby form a coating. In case the beam 61 emitted by the source of radiation 44 does not travel through the opening 53 of the mask 45, but reaches the mask 45, then no energy is supplied by the beam 61 to the orifice surface 43, but the energy is prevented to be supplied to the orifice surface 43 by the mask 45. Due to the relative movement, the position of the opening 53 of the mask 45, with respect to the orifice surface 43 and the source 44 of radiation changes with time. At a certain moment, energy may be supplied to a first part of the orifice surface 43, whereas at another moment, energy may be supplied to a second part of the orifice surface 43. Hence, the part of the orifice surface 43 that is supplied with energy by irradiation may be controlled and as a consequence, the part of the orifice surface 43 on which a coating is applied also changes with time. In FIG. 10, the beam 61 is shown as a non-divergent beam 61. However, in an alternative embodiment, the beam may be a divergent beam. In that case, the area of the orifice surface 43 that is irradiated does not only depend on the size of the opening 53 of the mask 45, but also depends on the distance between the source 44 of radiation and the mask 45 and on the distance between the mask 45 and the orifice surface 43 and on the thickness of the mask 45. In a particular embodiment, the velocity v is varied for the above mentioned control. The source 44 of radiation may be moved fast in an area far away from the orifice 8. Consequently, little energy is supplied in that area, such that no coating or a low coverage of coating may be formed on an area of the orifice surface 43 far away from the orifice 8. Above an area of the orifice surface 43 close to the orifice 8, the source 44 of radiation is moved slowly, such that the area of the orifice surface 43 is supplied with energy by irradiation for a relatively long period of time. As a consequence, more energy is supplied to an area of the orifice surface 43 close to the orifice 8 and therefore, more compound 41 for forming a coating bonds to the surface 43 and a higher coverage of coating is obtained on the orifice surface 43 close to the orifice 8.

In an alternative embodiment, a wetting gradient may also be applied to the orifice surface 43 by moving the source 44 of radiation and the orifice plate with respect to one another with varying velocity, without the use of the mask 45. By moving the source 44 of radiation and/or the orifice plate, such that an area of the orifice surface 43 close to the orifice 8 is irradiated longer than an area of the orifice surface away from the orifice 8. Consequently, locally a higher coverage op the coating may be applied on the orifice surface 43, without the use of the mask 45.

FIG. 10A-D show a cross-section of the orifice plate 42 comprising the orifice surface 43, the orifice plate 42 being arranged to be in contact with the medium 40 comprising the compound 41 for forming the coating. The source 44 of electromagnetic radiation is provided to supply radiation to the orifice surface 43 and the compound 41. A first mask 45a is placed between the orifice surface 43 and the source 44 of radiation and a second mask 45b is placed between the orifice surface 43 and the source 44 of radiation. The first and the second mask 45a, 45b may be moved with constant velocity or with a locally varied velocity. The two masks 45a, 45b are moved in opposite direction, substantially parallel to the orifice surface 43. The two masks 45a, 45b are positioned such that they cross one another above the orifice 8 (FIG. 10B).

In FIG. 10A, the two masks 45a, 45b are both in a position far away from the orifice 8. The first mask 45a is positioned above the orifice surface 43 on one side of the orifice 8, the second mask is positioned above the orifice surface 43 on the other side of the orifice 8. The orifice surface 43 is irradiated by the source 44 of electromagnetic radiation. The areas of the orifice surface 43 that are positioned underneath one of the first and second masks 45a, 45b, are not irradiated and are therefore not supplied with energy. The areas of the orifice surface 43 that are not positioned underneath one of the first and second masks 45a, 45b are irradiated and are therefore supplied with energy.

FIG. 10B shows the positions of the first and second mask 45a, 45b with respect to the orifice surface 43 and the source of radiation 44 after a certain period of time with respect to the situation shown in FIG. 10A. Now, the first and second mask 45a, 45b have moved and are positioned above one another, above the orifice 8. In this situation, no energy is supplied to the part of the orifice surface 43 close to the orifice 8.

FIG. 10C shows the positions of the first and second mask 45a, 45b with respect to the orifice surface 43 and the source 44 of radiation after a certain period of time with respect to the situation shown in FIG. 10B. The first and the second mask 45a, 45b are no longer positioned above one another. Therefore, an area above the orifice is irradiated by the source 44 of electromagnetic radiation.

FIG. 10D shows the positions of the first and second mask 45a, 45b with respect to the orifice surface 43 and the source 44 of radiation after a certain period of time with respect to the situation shown in FIG. 10C. The first and second mask 45a, 45b are no longer positioned above the orifice 8. The second mask 45b is positioned above the orifice surface 43 at one side of the orifice 8 and the first mask is positioned above the orifice surface 43 at the other side of the orifice 8. The areas underneath the first and second mask 45a, 45b are prevented from irradiation by the masks 45a, 45b, whereas energy is supplied to areas of the orifice surface 43 not covered by one of the masks 45a, 45b, such as the area of the orifice surface 43 close to the orifice 8.

The area of the orifice surface 43 close to the orifice 8 is prevented from irradiation for a shorter period of time than an area of the orifice surface 43 further away from the orifice. This is because above the orifice, the two masks 45a, 45b cross one another. A relative amount of energy E (vertical axis) locally supplied to the orifice surface 43 is schematically shown in FIG. 10D. Most energy E is supplied to the area close to the orifice 8 and therefore, a higher coverage of coating is obtained at the orifice surface 43 close to the orifice 8, as explained above.

FIG. 11 shows the orifice surface 43 of the orifice plate 42. The orifice plate 42 comprises the orifice 8. A wetting coating providing a wetting gradient is applied around the orifice 8. The wetting gradient is formed by applying a first coating on the orifice surface 43 around the orifice 8, wherein the coverage of the coating decreases with increasing distance from the orifice 8. The area, on which the first coating is applied, may be deemed confined by the virtual border 47. Outside the virtual border 47, no first coating is applied. On the areas 50 of the orifice surface 43 where no first coating is applied, a second coating may be applied. The second coating may be applied, for example by chemical vapor deposition, by removing the medium comprising the compound 41 for forming a coating and replace the medium with a second medium comprising a second compound for forming a second coating on the surface upon irradiation of the surface through said second medium, etc.

By applying a second coating having properties different from the properties of the first coating, the wetting properties of the surface 43 may be further improved. Please note that the wetting properties of the coated surface 43 should be judged compared to the wetting properties of an uncoated surface 43. Moreover, the wettability also depends on the nature of the fluid that may be present on the surface 43. For example, when applying a wetting coating, the wettability of the surface 43 provided with the wetting coating should be higher than the wettability of the uncoated surface 43. Thus, if the wettability of the uncoated surface 43 is high, the wettability of the coated surface 43 should be even higher, in order to obtain a wetting coating. As explained above, applying the first coating around the orifice 8, wherein the coverage of the coating decreases with increasing distance from the orifice 8 generates a driving force for a droplet of marking material to flow. In case the first coating is wetting, the orifice surface 43 may be more wetting close to the orifice 8 and marking material may flow towards the orifice 8 and in case the first coating is anti-wetting, the orifice surface 43 may be least wetting close to the orifice 8 and marking material may flow away from the orifice 8. As mentioned above, the second coating may have different properties compared to the first coating. Applying a second coating on the orifice surface 43 may generate an additional driving force. For example, applying an anti-wetting coating around an area where an wetting gradient is provided by application of an anti-wetting coating does not provide an additional driving force for the marking material to flow further away from the orifice 8. If the first coating is anti-wetting, then the second coating may be a wetting coating. By application of a wetting gradient on the basis of the first coating, marking material may flow away from the orifice 8. By applying a second coating, which may be wetting, an additional driving force may be created for the marking material to move ever further away from the orifice 8.

Alternatively, an area near the virtual border of the wetting gradient may be provided with a low coverage of the first coating. Locally, the orifice surface 43 may be able to bond more compound for forming a coating. Therefore, the second coating may be applied to an area of the orifice surface 43 within the virtual borders 47 of the wetting gradient, such that an area directly surrounding the orifice 8 is provided with a first coating, the area outside the virtual border 47 is provided with a second coating and an area in between the virtual border 47 and the area directly surrounding the orifice 8 is provided with both a first and a second coating, wherein relative more first coating is present closer to the orifice 8 and relatively more second coating is present close to the virtual border 47.

Two embodiments of a orifice surface 43, provided with a first and a second coating have been described. However, a wetting gradient can be generated in alternative ways as well. For example, the gradient of coverage of the coating around the orifice 8 may be varied; the coverage may increase or may decrease with increasing distance from the orifice 8. The virtual border 47, which confines the area, of the orifice surface 43, on which the first coating is applied, may be close to the orifice 8 or may be further removed from the orifice 8. The second coating may be applied only on a part of the surface outside of the virtual border 47, or a part of the orifice surface within the virtual border 47, having a low coverage of the first coating, may also be provided with a coverage of the second coating. The above cited parameters may be varied independently.

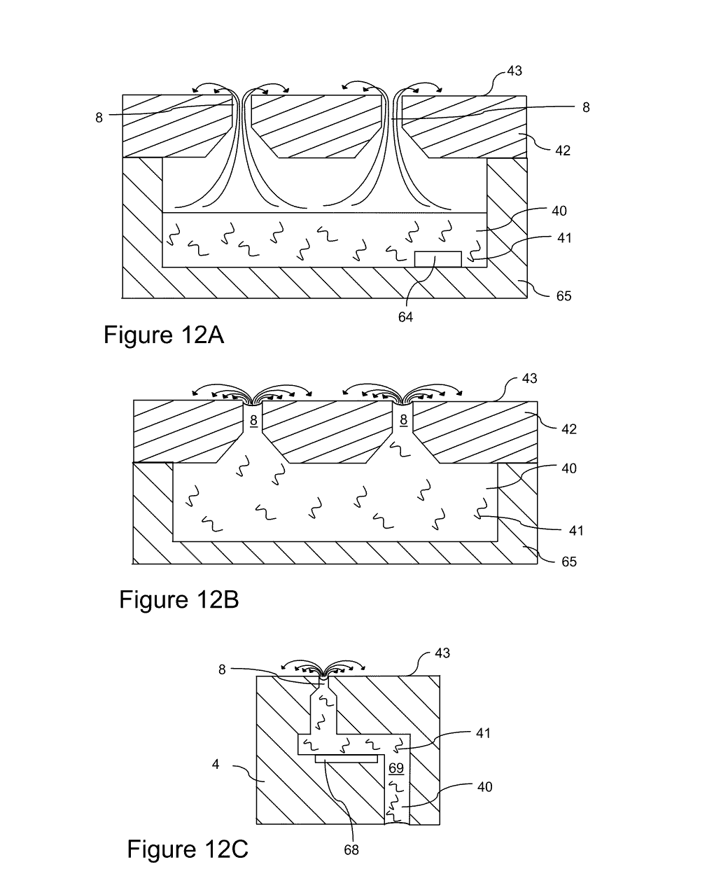

FIG. 12A shows a cross-section of an orifice surface 43, comprising an orifice 8. The orifice surface 43 is a part of an orifice plate 42. The orifice plate 42 is arranged on top of a vessel 65. The vessel 65 and the orifice plate 42 together form a reservoir. The reservoir is partially filled with a medium 40. The medium 40 may be a liquid solution, for example. The medium 40 comprises a compound 41 for forming a coating on the orifice surface 43. Please note that in an alternative embodiment, neat compound 41 for forming the coating may be provided to the reservoir. Conditions are applied to the system, such that the compound 41 for forming the coating evaporates. Optionally, the medium 40 may evaporate, but this is not necessary. Upon evaporation of the compound 41 for forming the coating, the compound 41 for forming the coating starts diffusing throughout the reservoir. When diffusing throughout the reservoir, the compound 41 may arrive at a first end of the orifice 8 and diffuse through the orifice 8, arriving at the second end of the orifice 8, where the orifice surface 43 is arranged. Once the evaporated compound 41 has diffused through the orifice 8, the compound 41 may start diffusing away from the orifice 8. Upon diffusing away from the orifice 8, a gradient in concentration of the compound 41 is formed, wherein the concentration is highest close to the orifice 8 and wherein the concentration is lower further away from the orifice 8. At a position remote from the orifice 8, there may be no evaporated compound 41 present at all. When the compound 41 for forming the coating diffuses away from the orifice 8, the compound may contact the orifice surface 43. The compound 41 may bond spontaneously to the orifice surface 43 when contacting the orifice surface 43. This means that the compound 41 may bond to the orifice surface 43 without the need to apply additional energy to the compound 41 and the orifice surface 43 under the conditions applied to the system. By bonding of the compound 41 to the orifice surface, a coating is formed on the orifice surface 43. Since there is a gradient in concentration of the compound 41 in the vapor phase, whereby the concentration is highest close to the orifice 8, there is more compound 41 present to bond to the orifice surface 43 close to the orifice 8. Less compound 41 is present to bond to the orifice surface 43 further away from the orifice 8. Hence, on a part of the orifice surface 43 close to the orifice 8, a coating is formed having a higher coverage, whereas a coating having a lower coverage is formed on a part of the orifice surface 43 further away from the orifice 8. Consequently, a coating is provided on the orifice surface 43 around the orifice 8, wherein the coverage of the coating decreases with increasing distance from the orifice 8. Provided that the coating has either wetting or anti-wetting properties, a wetting gradient is generated around the orifice 8.

The parameters should be suitably controlled during the evaporation process and before. Parameters, like temperature, pressure, concentration of the compound 41 in the medium 40, rate of evaporation of the compound 41, the geometry of the orifice 8 and the nature of the compound 41 for forming the coating, but also other parameters, may influence the generation of the wetting gradient. Please note that there is an upper limit to the coverage and supplying more compound by evaporating the compound 41 from the medium 40 than required to provide such a maximum coverage does not lead to an even higher coverage. Therefore, it is, important to expose the orifice surface 43 to the compound 41 for a predetermined period of time. Once the maximum coverage has been reached on a part of the orifice surface 43 close around the orifice 8 and the orifice surface 43 is still exposed to the evaporated compound 41, also further away from the orifice 8 the maximum coverage of coating may be reached. In that case, the initially formed gradient around the orifice 41 is converted into a layer of coating, having a continuous coverage of coating throughout the surface 43 and no gradient is provided anymore. Therefore, the amount of time, during which the orifice surface 43 is exposed to the evaporated compound 41 for forming the coating should be suitably controlled. As stated above, the compound 41 for forming the coating may not only diffuse through the orifice 8, it may also diffuse throughout the reservoir, formed by the vessel 65 and the orifice plate 42. Therefore, also surfaces of the vessel 65 and orifice plate 42 may be in contact with the compound 41, either in the medium 40 or in the vapor phase. Depending on the material, of which the surfaces of the vessel 65 and the orifice plate 42 consist and on the conditions in the reservoir, the compound 41 for forming the coating may bond to the surfaces of the vessel 65 and the orifice plate 42, providing these surfaces with a coating.

Furthermore, heating means 64 are provided in the reservoir to heat the medium 40 comprising the compound 41. Generally, the rate of evaporation is higher at a higher temperature. Thus, by heating the medium 40 and thereby heating the compound 41, the wetting gradient may be applied to the orifice surface 43 in a shorter period of time. The heating means 64 may be provided or may not be provided, depending on the conditions applied and on the properties, such as boiling point, of the medium 40 and the compound 41. Alternatively, cooling means may be provided to suitably control the temperature of the compound 41.

In a particular embodiment, a reservoir contained neat tridecafluoro-1,1,2,2,-tetrahydro-octyl-trichlorosilane as the compound for forming the coating. The reservoir as well as the orifice plate were placed in a nitrogen atmosphere, at a pressure of 0.5 mbar and at room temperature. On top of the orifice plate, a layer of single side polished (SSP) silicon was positioned, the polished side of the silicon layer pointing away from the orifice surface. The compound was evaporated and diffused through the orifice and the SSP silicon layer, during 30 seconds forming a wetting gradient around the orifice.

FIG. 12B shows a cross-section of the orifice surface 43 comprising the orifices 8. Like in FIG. 12A, the orifice plate 42 is positioned on top of the vessel 65, creating the reservoir. The medium 40 comprising the compound 41 for forming the coating is provided to the reservoir. In this embodiment, the reservoir is completely filled with the medium 40 comprising the compound 41. In this case, after evaporation of the compound 41, the compound cannot diffuse throughout the reservoir, but will evaporate through the orifice to the second end of the orifice, where the orifice surface 43 is arranged. A gradient in concentration is then created in the vapour phase surrounding the orifice plate 43, wherein the concentration is highest close to the orifice 8. As explained above, the gradient in concentration in the vapour phase is transferred to the orifice surface 43 by bonding of the compound 41 for forming the coating to the orifice surface 43, thereby creating a wetting gradient around the orifice 8. As stated above, the orifice surface 43 should not be immersed in the medium 40 comprising the compound 41, because in that case, the compound will bond to the orifice surface 43 forming a homogeneous coverage of compound on the part of the orifice surface that is provided with the medium and hence, no gradient will be obtained.

FIG. 12C shows a cross section of the orifice surface 43 comprising the orifice 8. In this embodiment, the wetting gradient is not applied to the orifice plate 42 comprising the orifice surface 43, but the gradient is applied to the orifice surface 43 of a print head 4, which does not comprise the orifice plate 42, but is formed out of one piece. The print head 4 comprises an ink channel 69 for containing ink, which is in fluid communication with the orifice 8. The print head 4 further comprises actuation means 68, for actuating a droplet of marking material through the orifice 8, when printing. Alternatively, to apply a wetting gradient on the orifice surface 43, the medium 40 comprising the compound 41 for forming the coating may be supplied to the ink channel 69, said ink channel then functioning as the reservoir. The reservoir may be completely filled with the medium 40 or a part of the reservoir may be filled with the medium 40. Upon evaporation of the compound 41 for forming the coating, the wetting gradient may be provided on the orifice surface 43, like described with reference to FIGS. 12A-B.

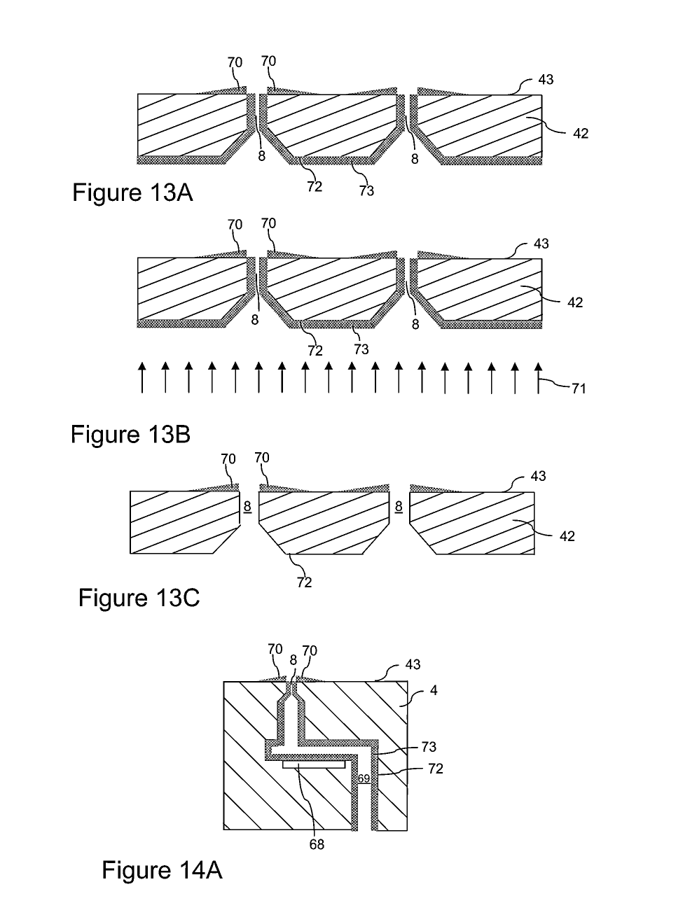

FIG. 13A shows a cross section of the orifice plate 42, comprising the orifice surface 43, the orifice surface 43 comprising the orifice 8. On the orifice surface 43, a wetting gradient 70 has been applied. For clarity reasons, the wetting gradient 70 is schematically depicted as a coating, having decreasing thickness. However, in reality, the wetting gradient is a coating, wherein the coverage of the coating (amount of compound 41 bond to the surface 43 per unit area) decreases. Since not only the orifice surface 43 has been in contact with the vapour of the compound 41 for forming the coating, a coating is not only applied on the orifice surface 43. In step a) of the method according to the present invention, the medium 40 comprising the compound 41 was supplied to the reservoir. The reservoir is formed by at least a second surface 72. During step b) of the method, the compound 41 for forming the coating evaporates. The compound 41 may diffuse through the orifice 8. In addition, the compound 41 may also diffuse through the reservoir and bond to the second surface 72, forming a coating 73. Alternatively, also compound 41 present in the medium 40 may bond to the second surface, forming the coating 73. Thus, when applying a wetting gradient 70 around the orifice 8 on the orifice surface 43, a coating may additionally be applied to the second surface 72. It may be advantageous to remove the coating 73 from the second surface 72, for example in case the coating 73 is an anti-wetting coating. After application of the wetting gradient 70 on the orifice surface 43, the orifice plate 42 may be incorporated in a print head. The presence of the anti-wetting coating 73 may prevent the inside of the print head from being wetted by the marking material, which may negatively influence the jetting performance of the print head.

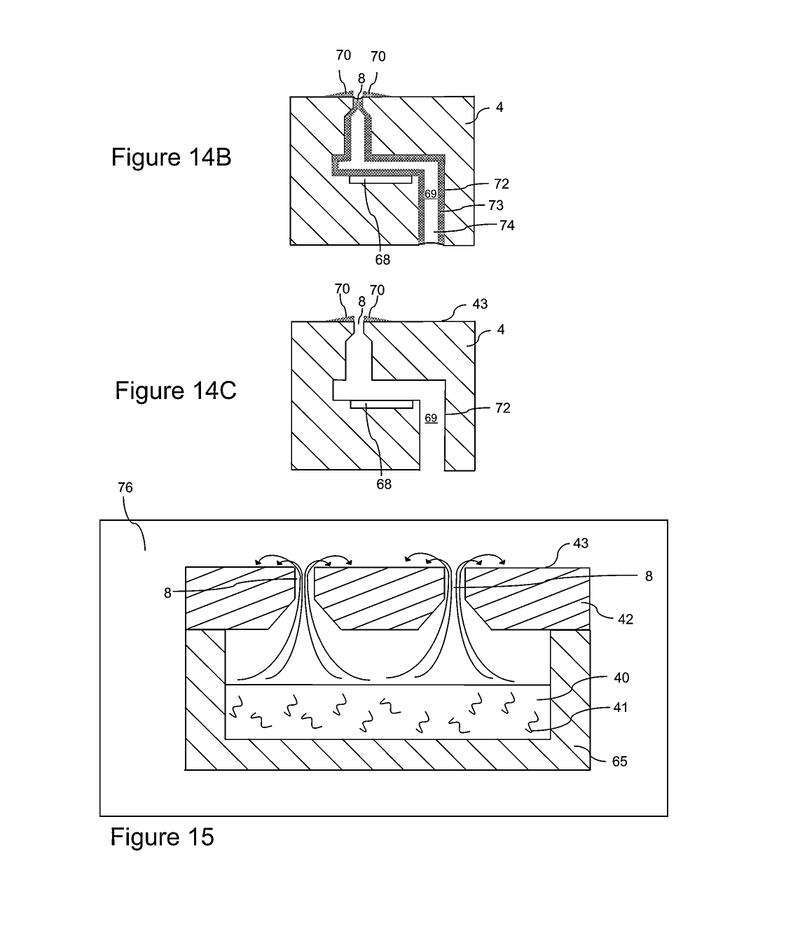

FIG. 13B shows a cross-section of the orifice plate 42, comprising the orifice surface 43. The wetting gradient 70 is provided on the orifice surface 43 and a coating 73 is provided to the second surface 72. The coating 73 present on the second surface 72 may be selectively removed. FIG. 13B shows that the second surface is irradiated with laser beams 71. Upon irradiation of the coating 73 present on the second surface 72, the coating 73 is removed. The coating 73 is selectively removed; by suitably arranging the laser beams 71 with respect to the second surface 72 and with respect to the orifice surface 43, only the coating 73 present on the second surface 72 is removed, leaving the wetting gradient 70 on the orifice surface 43 unchanged. Optionally, the coating 73 may be removed from the second surface 72 using beams of radiation, different from laser beams. Alternatively, the coating may be removed by etching, as is explained below with reference to FIG. 14B.

FIG. 13C shows a cross-section of the orifice surface 43 provided with the wetting gradient 70 around the orifice 8. No coating is present on the second surface 72. Therefore, the presence of a coating can no longer negatively influence the jetting behaviour while printing. However, droplets of marking material may still be removed efficiently from the vicinity of the orifice 8.

An alternative method to prevent the presence of an unwanted coating on the second surface 72, is to apply a protective coating on the second surface 72, different from the coating forming the wetting gradient, before the wetting gradient 70 is applied to the orifice surface 43 by evaporation. The protective coating applied to the second surface 72 may be e.g. a wetting coating. A wetting coating may allow the inside of the print head from being wetted by the marking material, which is beneficial for the jetting performance of the print head. The protective coating may be applied selectively to the second surface. Alternatively, the protective coating may be applied to the second surface 72 and to the orifice surface 43 and later be selectively removed from the orifice surface 43.

In step a), when providing the medium 40 comprising the compound 41 for forming the coating, the compound preferably should leave the protective coating intact. In step b), by evaporating the compound 41 through the orifice 8, a wetting gradient may be provided to the orifice surface 43 and no compound 41 will bond to the second surface anymore 72, thereby preventing the jetting performance of the print head 4a to be negatively influenced. Optionally, the protective coating may be selectively removed from the second surface after application of the coating providing the wetting gradient on the orifice surface.

FIG. 14A shows a cross-section of a print head 4, comprising the orifice 8. The wetting gradient 70 is provided around the orifice 8, for example in a method as shown above with reference to FIG. 12C. To a second surface 72 of the print head 4, a coating 73 is applied, since also the second surface 72 has been in contact with the compound 41 for forming the coating; the second surface 72 may at least locally have been in contact with the evaporated compound 41 and/or may at least locally have been in contact with the compound 41 present in the medium 40 and upon contact of the compound 41 to the second surface 72, the compound may have bond to the second surface 72. The presence of the coating 73 on the second surface 72 may be unwanted. For example if the coating 73 has anti-wetting properties, presence of the coating may prevent the ink channel 69 of the print head 4 from being wetted by marking material, thereby negatively influencing the jetting properties of the print head 4. With reference to FIGS. 13A-C, a method for removing the coating 73 from the second surface 72 was shown. There, the coating 73 was removed from the second surface 43 by irradiating the second surface. This method may be applied as well for the print head 4. However, because of the shape of the ink channel, it may be difficult to efficiently and accurately remove the coating 73 by irradiation.

FIG. 14B shows a cross-section of an orifice surface 43 comprising the orifice 8. The orifice surface 43 is provided with a wetting gradient 70 and the second surface 72 is provided with the coating 73. The ink channel 69 of the print head 4, forming the reservoir, is provided with coating removing means for removing the coating 73. In FIG. 14B, the coating removing means is a solution 74 for removing the coating 73, which is provided to the ink channel 69. The solution 74 for removing the coating 73 may for example be an etching solution. Alternatively, the ink channel 69, forming the reservoir may be provided with a gas for removing the coating 73. Furthermore, a plasma may be applied to remove the coating 73. In any case, it will be clear to the person skilled in the art that any suitable means may be provided to the ink channel 69 to remove the coating 73. The solution 74 for removing the coating does not contact the orifice surface 43, leaving the wetting gradient 70 provided around the orifice 8, unchanged. The solution 74 is left in the ink channel 69 for a predetermined amount of time, during which the compound 73 is removed from the second surface 72. Afterwards, the solution may be removed from the ink channel 69. Optionally, the orifice surface 43 may be protected from the coating removing means, for example by applying protective layer on the orifice surface 43. Especially when a gas or a plasma is chosen as coating removing means, it may be beneficial to protect the orifice surface 43 provided with the wetting gradient 70.

FIG. 14C shows a cross-section of the orifice surface 43 comprising the orifice 8. The wetting gradient 70 around the orifice 8 is still present, but the coating 73 on the second surface 72 is not present anymore. Therefore, the presence of a coating can no longer negatively influence the jetting behaviour while printing. However, droplets of marking material may still be removed efficiently from the orifice 8, because of the wetting gradient 70 present on the orifice surface 43.

FIG. 15 shows a cross-section of the orifice surface 43 comprising the orifice 8. The orifice surface 43 is part of the orifice plate 42. The orifice plate is positioned on top of the vessel 65, the orifice plate 42 and the vessel 65 forming the reservoir. A medium 40 comprising a compound 41 for forming the coating is provided in a part of the reservoir. A wetting gradient is provided on the orifice surface 43 around the orifice 8, as was described above with reference to FIG. 12A. However, in this embodiment, the orifice plate 42 and the vessel 65 are placed in a closed environment 76. By placing the orifice plate 42 and the vessel 65 in a closed environment 76, the parameters, under which the wetting gradient are applied, can be controlled more efficiently. For example, temperature and pressure may be controlled more efficiently. The temperature may be controlled by suitable temperature control means (not shown). Furthermore, the pressure may be reduced using suction means (not shown). Additionally, the presence of water vapour and/or oxygen may be efficiently prevented by placing the orifice plate 42 and the vessel 65 in a closed environment 76. The compound 41 for forming the coating and the material of the orifice surface 43 are selected such that they bond without the need for applying additional energy to the system. This implies that the compound 41 for forming the coating and the material of the orifice surface 43 have to be reactive towards one another. Suitable compounds 41 for forming the coating are for example compounds containing a Si—Cl bond, for example trichlorosilane compounds. Suitable materials for the orifice surface 43 are for example silicon (comprising SiO₂ groups), silanes (comprising —SiH groups), nickel coated with another metal, such as gold coated nickel, etc. Compounds containing a Si—Cl bond are generally reactive compounds, especially towards materials such as silicon. However, these compounds are sensitive to water and water vapour. Therefore, it is important to prevent water or water vapour to be present. In case the orifice surface 43 consists of silane, the presence of oxygen should be prevented. In any case, by placing the system in a closed environment, efficient control is provided to control the relevant parameters during application of the wetting gradient on the orifice surface 43.

Please note that, as stated above, the time during which compound 41 for forming the coating is evaporated and may bond to the orifice surface 43, should be suitably controlled. During the process of applying the wetting gradient, presence of components that may hamper the formation of the wetting gradient should be prevented. However, allowing these components to enter the system after the orifice surface 43 has been exposed to the evaporated compound 41 for a predetermined period of time may be a suitable method for efficiently stopping the formation of the wetting gradient and the amount of compound 41, locally bond to the orifice surface 43 may be suitably controlled. For example, when the compound 41 for forming the coating is a trichlorosilane compound and the orifice surface 43 consists of silicon, allowing water or water vapour to enter the system may be a suitable way of quenching the compound 41 for forming the coating, such that the formation of the wetting gradient stops.

The compound 41 for forming the coating may not only be selected for the reactivity towards the material of the orifice surface, it may also be suitable selected for providing the desired wetting or anti-wetting properties to the surface upon formation of the coating. For example, compound containing a —(CF₂)ₙCF₃ chain are generally suitable compounds for providing anti-wetting properties to the orifice surface 43. Please note that the wetting properties of the coated surface 43 should be judged compared to the wetting properties of an uncoated surface 43. Moreover, the wettability also depends on the nature of the fluid that may be present on the surface 43. For example, when applying a wetting coating, the wettability of the surface 43 provided with the wetting coating should be higher than the wettability of the uncoated surface 43. Thus, if the wettability of the uncoated surface 43 is high, the wettability of the coated surface 43 should be even higher, in order to obtain a wetting coating.

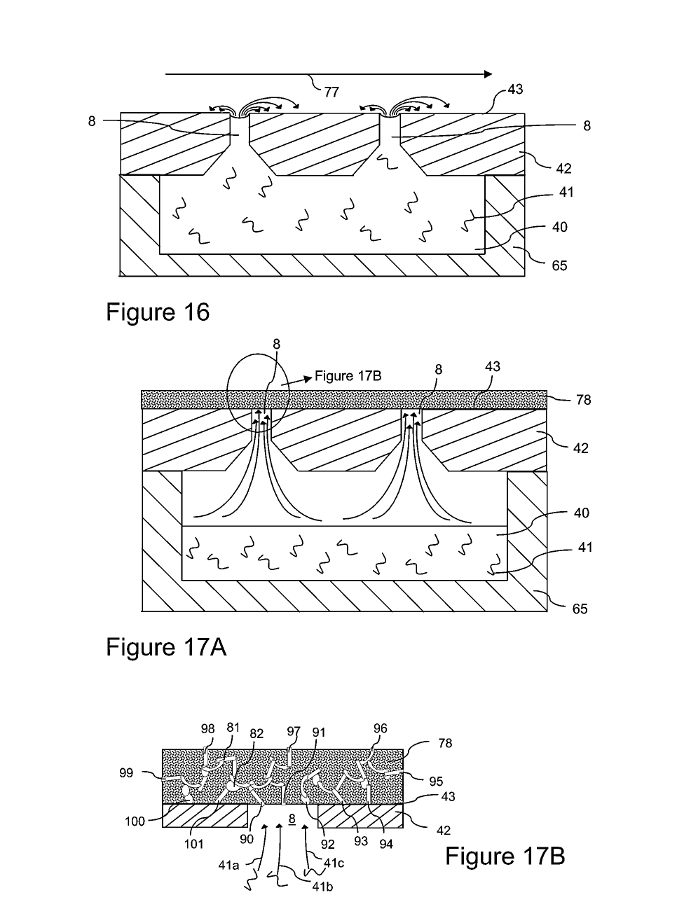

FIG. 16 shows a cross-section of the orifice surface 43 comprising the orifice 8. The orifice surface 43 is a part of the orifice plate 42. The orifice plate 42 is positioned on top of the vessel 65, the orifice plate 42 and the vessel 65 forming the reservoir. The medium 40 comprising the compound 41 for forming the coating is provided to the reservoir. The compound 41 for forming the coating is evaporated and diffuses through the orifice 8. During evaporation of the compound 41, an airflow 77 is generated. The airflow 77 is generated in a direction substantially parallel to the orifice surface 43. The size and the shape of the coating applied on the orifice surface 43 around the orifice 8 are suitably controlled by the airflow 77. In absence of the airflow 77, the compound 41, once it has diffused through the orifice 8, diffuses away from the orifice 8 and diffuses equally in all directions with respect to the orifice 8. By applying the airflow 77, a driving force is generated for the compound 41 to move in the direction of the airflow 77. Hence, by applying the airflow 77, more compound will move in the direction of an airflow 77 than in the opposite direction. However, depending on the speed of the airflow 77 and the rate of diffusion of the evaporated compound 41, some compound may still diffuse in the direction opposite of the direction of the airflow, bond to the orifice surface 43, thereby forming a coating on the orifice surface 43. Thus, by applying the airflow 77 more coating is applied on one side of the orifice 8 and less coating is applied on the opposite side of the orifice 8. Consequently, by suitably controlling the airflow 77, the shape of the coating, applied on the orifice surface 43 may be suitably controlled. In case the airflow 77 has a higher speed, the compound 41 may move further away from the orifice 8, before it bonds to the orifice surface 43 and a larger area of the orifice surface 43 may be provided with the coating. Hence, by controlling the direction and the speed of the airflow 77, not only the shape, but also the size of the coating applied on the orifice surface 43 may be suitably controlled. In will be clear to the person skilled in the art, that although the use of an airflow 77 was mentioned, also different gasses may be applied. For example, in case the steps of the method according to the present invention are conducted in an inert atmosphere, for example in nitrogen or argon, the flow of air may be a flow of nitrogen or a flow of argon, respectively.

FIG. 17A shows a cross-section of the orifice surface 43 comprising the orifice 8. The orifice surface 43 is a part of the orifice plate 42. Alternatively, the orifice surface 43 may be part of a print head 4a, not comprising the orifice plate 42. The orifice plate 42 is positioned on top of the vessel 65, the orifice plate 42 and the vessel 65 forming the reservoir. The medium 40 comprising the compound 41 for forming the coating is provided to the reservoir. A layer of porous material 78 is placed on the orifice surface 43. The porous layer 78 comprises pores, such as channels and cavities.

The compound 41 is evaporated and diffuses throughout the reservoir—in case the reservoir is only partially filled with the medium 40- and diffuses through the orifice 8. The orifice surface 43 is covered with the layer of porous material 78. Therefore, the evaporated compound 41 cannot contact the orifice surface 43, because the orifice surface 43 is covered with the layer of porous material 78.

FIG. 17B shows a detail of FIG. 17A. In FIG. 17B, the pores inside the layer of porous material 78 are schematically shown. The pores may be e.g. channels 81 or cavities 82. The pores of the porous material 78 may be accessible to the evaporated compound 41a, 41b, 41c. As a consequence, the evaporated compound 41a, 41b, 41c may enter one of the pores 90, 91, 92 of the layer of porous material 78. After entering one of the pores 90, 91, 92 of the porous material 78, the compound 41a, 41b, 41c may diffuse through the pores of the porous material 78. Eventually, the compound 41a, 41b, 41c may leave the porous material 78 via one of the pores. In case the compound 41a, 41b, 41c leaves the porous material 78 via a pore 93, 94,100, 101, located on the side of the layer of porous material contacting the orifice surface 43, then the compound 41a, 41b, 41c may contact the orifice surface 43 upon leaving the pore and may bond to the orifice surface 43, forming the coating on the orifice surface 43. On the other hand, in case the compound 41a, 41b, 41c leaves the porous material 78 via a pore 95-99, not located on the side of the layer of porous material 78 contacting the orifice surface 43, then the compound 41a, 41b, 41c does not bond to the orifice surface and does not provide the orifice surface 43 with coating.

The compound may diffuse within the pores of the porous material 78. Also within the porous material, a gradient in concentration forms, because of the diffusion process. Thus, the further away from the orifice 8, the less compound 41a, 41b, 41c is present within a pore of the porous material 78. Therefore, less compound 41a, 41b, 41c may diffuse out of the layer of porous material 78 at a position further away from the orifice 8 and a coating having a lower coverage is provided on a part of the orifice surface 43 further away from the orifice 8. However, compared to the formation of a wetting gradient according to any of the embodiments of the present invention not using porous material, there is a difference in the size of the area of the orifice surface 43 that is provided with the coating. This is caused by the presence of the pores 81, 82 within the porous material 78. Because of this pores, the evaporated compound 41a, 41b, 41c has to travel a different path to arrive at the orifice surface compared to the situation, wherein the compound 41a, 41b, 41c diffuses through the gas phase.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

1. A coating for providing a wetting gradient to an orifice surface around an orifice, the coating providing anti-wetting properties to the orifice surface, the coating having a local coverage, the local coverage being highest close to the orifice, the local coverage decreasing gradually with decreasing distance from the orifice, wherein the coating is distributed randomly.

2. A method for applying a wetting gradient on an orifice surface, the method comprising the steps of:
a) providing a compound for forming a coating on the orifice surface; and
b) locally bonding the compound to the orifice surface, thereby forming a coating for providing a wetting gradient to the orifice surface,
wherein in step b), the amount of the compound that locally bonds to the orifice surface is controlled, thereby controlling the local coverage of the coating, such that the local coverage is highest close to the orifice, and the local coverage decreases gradually with decreasing distance from the orifice and such that the coating is distributed randomly.

3. The method according to claim 2, wherein:
in step a), the orifice surface is arranged to be in contact with a medium comprising the compound for forming a coating on the orifice surface;
in step b), the orifice surface is locally irradiated through the medium with electromagnetic radiation, thereby locally supplying energy to the orifice surface and the compound to enable the orifice surface and the compound to locally bond to form the coating on the orifice surface; and
in step b), the method further comprises supplying a suitable amount of energy to the orifice surface and the compound such that locally a higher coverage of coating is obtained on the orifice surface by locally supplying a larger amount of energy.

4. The method according to claim 3, wherein an amount of energy is supplied close to the orifice and a smaller amount of energy is supplied at a larger distance from the orifice.

5. The method according to claim 4, wherein a source of electromagnetic radiation produces a beam of electromagnetic radiation, said beam having a non-uniform intensity profile, wherein the beam is directed to an orifice and wherein the radiation is most intense at a position of the orifice.

6. The method according to claim 4, wherein the beam is a laser beam and wherein a lens is placed between the source of the laser beam and the orifice surface to diverge the beam and to provide a larger amount of energy close to the orifice.

7. The method according to claim 3, wherein a mask is used to expose an area of the orifice surface to radiation.

8. The method according to claim 7, wherein the amount of energy supplied to the orifice surface is controlled by using at least a first and a second mask, wherein the first mask is used to expose a first area of the orifice surface to radiation and wherein the second mask is used to expose a second area of the orifice surface to irradiation and wherein the amount of energy supplied to the first area of the orifice surface differs from the energy supplied to the second area of the orifice surface.

9. The method according to claim 8, wherein the first area and the second area partially overlap.

10. The method according to claim 7, wherein the amount of energy supplied to the orifice surface by irradiation is controlled by means of optical transmission properties of the mask.

11. The method according to claim 7, wherein at least two of the mask, the orifice surface and the source of electromagnetic radiation move relative to one another.

12. The method according to claim 11, wherein the amount of energy supplied to the orifice surface by irradiation is controlled by moving at least one of the mask, the orifice surface and the source of electromagnetic radiation with varying velocity.

13. The method according to claim 7, wherein the amount of energy supplied to the orifice surface is controlled by using at least a first and a second mask, wherein the first mask is used to expose a first area of the orifice surface to radiation and wherein the second mask is used to expose a second area of the orifice surface to irradiation and wherein the two masks are moved in opposite direction.

14. The method according to claim 2, wherein the orifice surface comprises at least one orifice, the orifice surface being in fluid communication with a reservoir through the orifice, wherein:
in step a), the compound for forming the coating is provided in the reservoir,
in step b), the compound for forming the coating is evaporated, a vapour of the compound diffusing through the orifice and bonding to the orifice surface, thereby forming the coating; and
step b) further comprises: comprises controlling the evaporation of the compound such that the coating formed on the orifice surface provides a wetting gradient on the orifice surface.

15. The method according to claim 14, wherein in step b), an airflow is generated in a direction substantially parallel to the orifice surface to control the direction and the shape of the coating applied on the orifice surface around the orifice.

16. The method according to claim 14, wherein in step a), a layer of porous material is placed on the orifice surface to control the diffusion of the compound.

17. The method according to claim 14, wherein step b) further comprises reducing the pressure in the reservoir to improve evaporation of the compound for forming the coating.

18. The method according to claim 14, wherein step b) further comprises controlling the temperature of the compound to improve control over the evaporation of the compound for forming the coating.

19. The method according to claim 14, wherein the orifice surface and the reservoir for containing the compound are placed in a closed environment.

20. The method according to claim 14, wherein the reservoir is formed by at least a second surface and wherein the method further comprises:
c) removing the coating from the second surface of the orifice plate.

21. The method according to claim 20 wherein the coating is removed from the second surface by etching.

22. The method according to claim 20, wherein the coating is removed from the second surface using a laser beam.

23. The method according to claim 14, wherein the compound for forming the coating comprises a Si—Cl bond.

24. The method according to claim 23, wherein the compound is a trichlorosilane compound.

25. The method according to claim 14, wherein the orifice plate consists of a material, the material being selected from the group of silicon, silica, Ni or metal-coated Ni.

26. The method according to claim 2, wherein the coating applied in accordance with the steps a) and b) is a first coating, the method further comprising applying a second coating at a part of the orifice surface not coated with the first coating, and wherein one of the first and second coating is a wetting coating and the other one of the first and second coating is an anti-wetting coating.

27. The method according to claim 26, wherein the second coating is applied by chemical vapor deposition.

28. A print head provided with an orifice surface, the orifice surface having arranged therein an orifice and the orifice surface having a wetting gradient around the orifice, wherein the wetting gradient has been applied to the orifice plate by the method according to claim 2.
